(19) United States
(12) Patent Application Publication
(10) Pub. No.: US 2022/0128798 A1
(43) Pub. Date: Apr. 28, 2022

(54) OPTICAL SYSTEM, LENS MODULE, AND ELECTRONIC DEVICE

(71) Applicants: OFILM GROUP CO., LTD., Shenzhen (CN); JIANGXI JINGCHAO OPTICAL CO., LTD., Nanchang (CN)

(72) Inventors: Nini WANG, Shenzhen (CN); Binbin LIU, Shenzhen (CN); Ming LI, Shenzhen (CN); Hairong ZOU, Shenzhen (CN)

(21) Appl. No.: 17/354,462

(22) Filed: Jun. 22, 2021

Related U.S. Application Data
(63) Continuation-in-part of application No. PCT/CN2020/123364, filed on Oct. 23, 2020.

(51) Int. Cl. G02B 13/00; G02B 9/64

(52) U.S. Cl. CPC G02B 13/0045; G02B 9/64

(57) ABSTRACT

An optical system, a lens module, and an electronic device are provide. The optical system includes a first lens having a positive refractive power, a second lens having a refractive power, a third lens having a refractive power, a fourth lens having a refractive power, a fifth lens having a refractive power, a sixth lens having a positive refractive power, a seventh lens having a negative refractive power which are sequentially arranged from an object side to an image side along an optical axis of the optical system. The first lens has an object-side surface which is convex near the optical axis. The seventh lens has an image-side surface which is concave near the optical axis. The optical system satisfies the following expression: 4≤(Y72*TL)/(ET7*f)≤10.

### CROSS-REFERENCE TO RELATED APPLICATIONS

The present application is a continuation-in-part of International Application No. PCT/CN2020/123364, filed on Oct. 23, 2020, the disclosure of which is hereby incorporated by reference in its entirety.

### TECHNICAL FIELD

The present disclosure relates to the field of optical imaging technology, and particularly to an optical system, a lens module, and an electronic device.

### BACKGROUND

Currently, with the rapid development of technology, consumers have increasingly higher requirements for imaging quality of mobile electronic products. In order to meet requirements of higher-order imaging system and realize a wide-angle shooting, various types of portable electronic device capable of shooting adopt a seven-element lens. However, the existing seven-element lens cannot meet requirements of both large field angle and miniaturization.

### SUMMARY

An optical system, a lens module, and an electronic device are provide to solve the above technical problems.

An optical system is provided according to implementations of the present disclosure. The optical system includes a first lens having a positive refractive power, a second lens having a refractive power, a third lens having a refractive power, a fourth lens having a refractive power, a fifth lens having a refractive power, a sixth lens having a positive refractive power, a seventh lens having a negative refractive power which are sequentially arranged from an object side to an image side along an optical axis of the optical system. The first lens has an object-side surface which is convex near the optical axis. The seventh lens has an image-side surface which is concave near the optical axis. The optical system satisfies the following expression: 4≤(Y72*TL)/(ET7*f)≤10. Y72 represents a maximum optical effective radius of the image-side surface of the seventh lens. TL represents a distance along the optical axis from the object-side surface of the first lens to an imaging plane of the optical system. ET7 represents a distance along the optical axis from an object-side surface of the seventh lens at a maximum optical effective radius to the image-side surface of the seventh lens at the maximum optical effective radius. f represents a focal length of the optical system. In the disclosure, a surface shape and the refractive power of each lens of the first to seventh lenses are rationally set, such that the seven-element optical system can meet the requirements of high pixels and good imaging quality.

When the optical system satisfies the above expressions, a balance between large field angle and thickness of the optical system can be realized, ensuring the yield of the seventh lens as well as reducing the size of the optical system.

In an implementation, the optical system satisfies the following expression: 2≤TL/EPD≤3. EPD represents an entrance pupil diameter of the optical system. When the optical system satisfies the above expression, the total length of the optical system can be reduced and the amount of incident light can be increased.

In an implementation, the optical system satisfies the following expression: 9≤(|AL1S1|+|AL2S1|)/f≤20. AL1S1 represents a maximum value of an acute angle between a tangent plane within a maximum optical effective radius of the object-side surface of the first lens and a plane perpendicular to the optical axis. AL1S2 represents a maximum value of an acute angle between a tangent plane within a maximum optical effective radius of the object-side surface of the second lens and the plane perpendicular to the optical axis. When the optical system satisfies the above expression, production sensitivity of first lens can be reduced and a larger field angle can be achieved.

In an implementation, the optical system satisfies the following expression: 0≤MVd/f≤20. MVd represents an average of Abbe numbers of the first to seventh lenses. When the optical system satisfies the above expression, chromatic aberration can be balanced, a match between different Abbe numbers and different refractive indexes is realized, and large field angle and good optical imaging performance can be achieved through combining different materials.

In an implementation, the optical system satisfies the following expression: 0≤ET1/(CT1*f)≤1 mm⁻¹. ET1 represents a distance along the optical axis from the object-side surface of the first lens at a maximum optical effective radius to an image-side surface of the first lens at a maximum optical effective radius. CT1 represents a thickness of the first lens along the optical axis. When the optical system satisfies the above expression, it is beneficial to molding the first lens.

In an implementation, the optical system satisfies the following expression 0≤ET7/(CT7*f)≤1 mm⁻¹. CT7 represents a thickness of the seventh lens along the optical axis. When the optical system satisfies the above expression, it is beneficial to molding the seventh lens.

In an implementation, the optical system satisfies the following expression: 0≤EPD/f≤1. EPD represents an entrance pupil diameter of the optical system. When the optical system satisfies the above expression, a balance between the amount of incident light and a rearward movement of the imaging plane can be achieved, and a large aperture and a large field angle can be realized.

In an implementation, the optical system satisfies the following expression: 0≤(MIN6*MAX7)/(MAX6*MIN7)≤1. MIN6 represents a minimum thickness of the sixth lens along the optical axis within a maximum optical effective radius. MAX6 represents a maximum thickness of the sixth lens along the optical axis within the maximum optical effective radius. MIN7 represents a minimum thickness of the seventh lens along the optical axis within a maximum optical effective radius. MAX7 represents a maximum thickness of the seventh lens along the optical axis within the maximum optical effective radius. When the optical system satisfies the above expression, a yield of injection molding can be improved, and a balance between a large field angle and astigmatism can be realized.

In an implementation, the optical system satisfies the following expression: 0≤(CT5+CT7)/CT6≤2. CT5 represents a thickness of the fifth lens along the optical axis. CT6 represents a thickness of the sixth lens along the optical axis. CT7 represents a thickness of the seventh lens along the optical axis. When the optical system satisfies the above expression, it is beneficial to enlarging the field angle and balancing aberrations.

In an implementation, the optical system satisfies the following expression: 1≤TL/ImgH≤2. ImgH represents half of an image height corresponding to a maximum field angle of the optical system. When the optical system satisfies the above expression, it is beneficial to realizing the miniaturization of the optical system.

In an implementation, a lens module is provided according to implementations of the present disclosure. The lens module includes a lens barrel, an electronic photosensitive element, and the above optical system. The optical system is mounted in the lens barrel, and the electronic photosensitive element is arranged at the image side of the optical system. The electronic photosensitive element is arranged at the image side of the optical system and used to convert light passing through the first to seventh lenses and incident on the electronic photosensitive element into an electrical signal of an image. In the present disclosure, the first to seventh lenses of the optical system are installed in the lens module, a surface shape and refractive power of each lens of the first to seventh lenses are reasonably set, such that the optical system of the seven-element lens meet both large field angle and miniaturization.

In an implementation, an electronic device is provided according to implementations of the present disclosure. The electronic device includes a housing and the above-mentioned lens module. The lens module is received in the housing. In the present disclosure, the lens module is installed in the electronic device, such that the electronic device can meet both large field angle and miniaturization.

As described above, the optical system with the seven-element lens of the disclosure has a compact space arrangement, thereby realizing a wide-angle imaging and allowing the optical system to be light and thin and have a short overall length. Moreover, the refractive power is reasonably distributed, such that an aberration of the overall optical system is balanced, sensitivity of the optical system is lowered, and mass production and processing can be carried out to meet the current market demand.

### BRIEF DESCRIPTION OF THE DRAWINGS

To describe the technical solutions in the implementations of the present disclosure or the related art more clearly, the following briefly introduces the accompanying drawings required for describing the implementations or the related art. Apparently, the accompanying drawings in the following description illustrate some implementations of the present disclosure. Those of ordinary skill in the art may also obtain other drawings based on these accompanying drawings without creative efforts.

FIG. 1a is a schematic structural view of an optical system according an implementation.

FIG. 1b illustrates a longitudinal spherical aberration curve, an astigmatic field curve, and a distortion curve of the optical system of FIG. 1a.

FIG. 2a is a schematic structural view of an optical system according to an implementation.

FIG. 2b illustrates a longitudinal spherical aberration curve, an astigmatic field curve, and a distortion curve of the optical system of FIG. 2a.

FIG. 3a is a schematic structural view of an optical system according an implementation.

FIG. 3b illustrates a longitudinal spherical aberration curve, an astigmatic field curve, and a distortion curve of the optical system of FIG. 3a.

FIG. 4a is a schematic structural view of an optical system according to an implementation.

FIG. 4b illustrates a longitudinal spherical aberration curve, an astigmatic field curve, and a distortion curve of the optical system of FIG. 4a.

FIG. 5a is a schematic structural view of an optical system according to an implementation.

FIG. 5b illustrates a longitudinal spherical aberration curve, an astigmatic field curve, and a distortion curve of the optical system of FIG. 5a.

FIG. 6a is a schematic structural view of an optical system according an implementation.

FIG. 6b illustrates a longitudinal spherical aberration curve, an astigmatic field curve, and a distortion curve of the optical system of FIG. 6a.

FIG. 7a is a schematic structural view of an optical system according to an implementation.

FIG. 7b illustrates a longitudinal spherical aberration curve, an astigmatic field curve, and a distortion curve of the optical system of FIG. 7a.

### DETAILED DESCRIPTION OF ILLUSTRATED IMPLEMENTATIONS

Technical solutions in the implementations of the present disclosure will be described clearly and completely hereinafter with reference to the accompanying drawings in the implementations of the present disclosure. Apparently, the described implementations are merely some rather than all implementations of the present disclosure. All other implementations obtained by those of ordinary skill in the art based on the implementations of the present disclosure without creative efforts shall fall within the protection scope of the present disclosure.

A lens module is provided according to an implementation of the present disclosure. The lens module includes a lens barrel, an electronic photosensitive element, and an optical system provided in implementations of the disclosure. First to seventh lenses of the optical system are installed in the lens barrel. The electronic photosensitive element is arranged at an image side of the optical system and used to convert light passing through the first to seventh lenses and incident on the electronic photosensitive element into an electrical signal of an image. The electronic photosensitive element may be a complementary metal oxide semiconductor (CMOS) or a charge-coupled device (CCD). The lens module can be an independent lens of a digital camera or an imaging module integrated on an electronic device such as a smart phone. In the present disclosure, the first to seventh lenses of the optical system are installed in the lens module, a surface shape and refractive power of each lens of the first to seventh lenses are reasonably set, such that the optical system of the seven-element lens meet both large field angle and miniaturization.

An electronic device is provided according to implementations of the present disclosure. The electronic device includes a housing and the lens module provided in implementations of the disclosure. The lens module and the electronic photosensitive element are received in the housing. The electronic device can be a smart phone, a personal digital assistant (PDA), a tablet computer, a smart watch, a drone, an e-book reader, a driving recorder, a wearable device, etc. In the present disclosure, the lens module is installed in the electronic device, such that the electronic device can meet both large field angle and miniaturization.

An optical system is provided according to implementations of the present disclosure. The optical system includes a first lens, a second lens, a third lens, a fourth lens, a fifth lens, a sixth lens, and a seventh lens which are sequentially arranged from an object side to an image side along an optical axis of the optical system. There is an air gap between adjacent ones of the first to seventh lenses.

In implementations of the disclosure, structure and shape of each of the first lens, the second lens, the third lens, the fourth lens, the fifth lens, the sixth lens, and the seventh lens are described in detail as follows.

The first lens has a positive refractive power and an object-side surface which is convex near the optical axis. The second lens has a refractive power. The third lens has a refractive power. The fourth lens has a refractive power. The fifth lens has a refractive power. The sixth lens has a positive refractive power. The seventh lens has a negative refractive power and an image-side surface which is concave near the optical axis. The optical system satisfies the following expression: 4≤(Y72*TL)/(ET7*f)≤10. Y72 represents a maximum optical effective radius of the image-side surface of the seventh lens. TL represents a distance along the optical axis from the object-side surface of the first lens to an imaging plane of the optical system. ET7 represents a distance along the optical axis from an object-side surface of the seventh lens at a maximum optical effective radius to the image-side surface of the seventh lens at the maximum optical effective radius. f represents a focal length of the optical system. In the disclosure, a surface shape and the refractive power of each lens of the first to seventh lenses are rationally set, such that the seven-element optical system can meet the requirements of high pixels and good imaging quality. When the optical system satisfies the above expressions, a balance between large field angle and thickness of the optical system can be realized, ensuring the yield of the seventh lens as well as reducing the size of the optical system.

In an implementation, the optical system satisfies the following expression: 2≤TL/EPD≤3. EPD represents an entrance pupil diameter of the optical system. As an example, the optical system satisfies the expression: 2.143≤TL/EPD≤1.294. When the optical system satisfies the above expressions, the total length of the optical system can be reduced and the amount of incident light can be increased.

In an implementation, the optical system satisfies the following expression: 9≤(|AL1S1|+|AL2S1|)/f≤20. AL1S1 represents a maximum value of an acute angle between a tangent plane within a maximum optical effective radius of the object-side surface of the first lens and a plane perpendicular to the optical axis. It is noted that, the tangent plane refers to a plane tangential to the object-side surface of the first lens at a point within the maximum optical effective radius of the object-side surface of the first lens. AL1S2 represents a maximum value of an acute angle between a tangent plane within a maximum optical effective radius of the object-side surface of the second lens and the plane perpendicular to the optical axis. As an example, the optical system satisfies the expression: 9.754≤(|AL1S1|+|AL2S1|)/f≤18.909. When the optical system satisfies the above expressions, production sensitivity of first lens can be reduced and a larger field angle can be achieved. It is noted that, the tangent plane refers to a plane tangential to the object-side surface of the second lens at a point within the maximum optical effective radius of the object-side surface of the second lens.

In an implementation, the optical system satisfies the following expression: 0≤MVd/f≤20. MVd represents an average of Abbe numbers of the first to seventh lenses. As an example, the optical system satisfies the expression: 12.114≤MVd/f≤16.05. When the optical system satisfies the above expressions, chromatic aberration can be balanced, a match between different Abbe numbers and different refractive indexes is realized, and large field angle and good optical imaging performance can be achieved through combining different materials.

In an implementation, the optical system satisfies the following expression: 0≤ET1/(CT1*f)≤1 mm⁻¹. ET1 represents a distance along the optical axis from the object-side surface of the first lens at a maximum optical effective radius to an image-side surface of the first lens at a maximum optical effective radius. CT1 represents a thickness of the first lens along the optical axis. As an example, the optical system satisfies the expression: 0.132 mm⁻¹≤ET1/(CT1*f)≤0.211 mm⁻¹. When the optical system satisfies the above expressions, it is beneficial to molding the first lens.

In an implementation, the optical system satisfies the following expression 0≤ET7/(CT7*f)≤1 mm⁻¹. CT7 represents a thickness of the seventh lens along the optical axis. As an example, the optical system satisfies the expression 0.324≤ET7/(CT7*f)≤0.528 mm⁻¹. When the optical system satisfies the above expression, it is beneficial to molding the seventh lens.

In an implementation, the optical system satisfies the following expression: 0≤EPD/f≤1. EPD represents an entrance pupil diameter of the optical system. As an example, the optical system satisfies the expression: 0.495≤EPD/f≤0.633. When the optical system satisfies the above expressions, a balance between the amount of incident light and a rearward movement of the imaging plane can be achieved, and a large aperture and a large field angle can be realized.

In an implementation, the optical system satisfies the following expression: 0≤(MIN6*MAX7)/(MAX6*MIN7)≤1. MIN6 represents a minimum thickness of the sixth lens along the optical axis within a maximum optical effective radius of an object-side surface of the sixth lens as well as a maximum optical effective radius of an image-side surface of the sixth lens. MAX6 represents a maximum thickness of the sixth lens along the optical axis within the maximum optical effective radius of the object-side surface of the sixth lens as well as the maximum optical effective radius of the image-side surface of the sixth lens. MIN7 represents a minimum thickness of the seventh lens along the optical axis within a maximum optical effective radius of the object-side surface of the seventh lens as well as a maximum optical effective radius of the image-side surface of the seventh lens. MAX7 represents a maximum thickness of the seventh lens along the optical axis within the maximum optical effective radius of the object-side surface of the seventh lens as well as the maximum optical effective radius of the image-side surface of the seventh lens. As an example, the optical system satisfies the expression: 0.15≤(MIN6*MAX7)/(MAX6*MIN7)≤0.364. When the optical system satisfies the above expressions, a yield of injection molding can be improved, and a balance between a large field angle and astigmatism can be realized.

In an implementation, the optical system satisfies the following expression: 0≤(CT5+CT7)/CT6≤2. CT5 represents a thickness of the fifth lens along the optical axis. CT6 represents a thickness of the sixth lens along the optical axis. CT7 represents a thickness of the seventh lens along the optical axis. As an example, the optical system satisfies the expression: 0.903≤(CT5+CT7)/CT6≤1.812. When the optical system satisfies the above expressions, it is beneficial to enlarging the field angle and balancing aberrations.

In an implementation, the optical system satisfies the following expression: 1≤TL/ImgH≤2. ImgH represents half of an image height corresponding to a maximum field angle of the optical system. As an example, the optical system satisfies the expression: 1.324≤TL/ImgH≤1.734. When the optical system satisfies the above expressions, it is beneficial to realizing the miniaturization of the optical system.

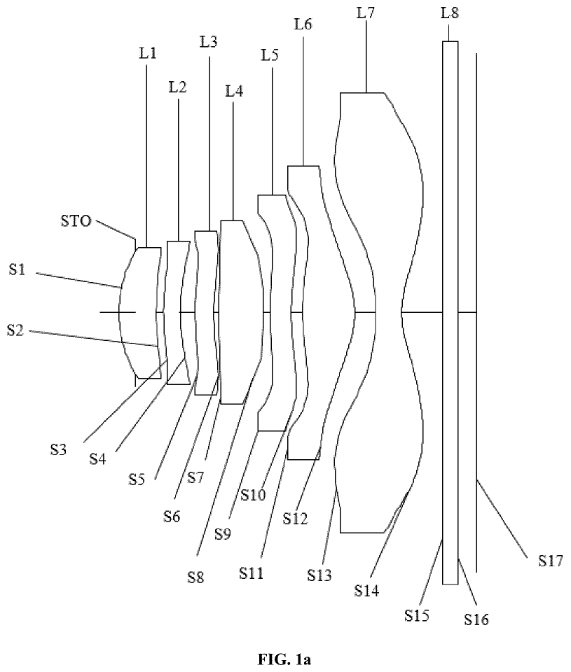

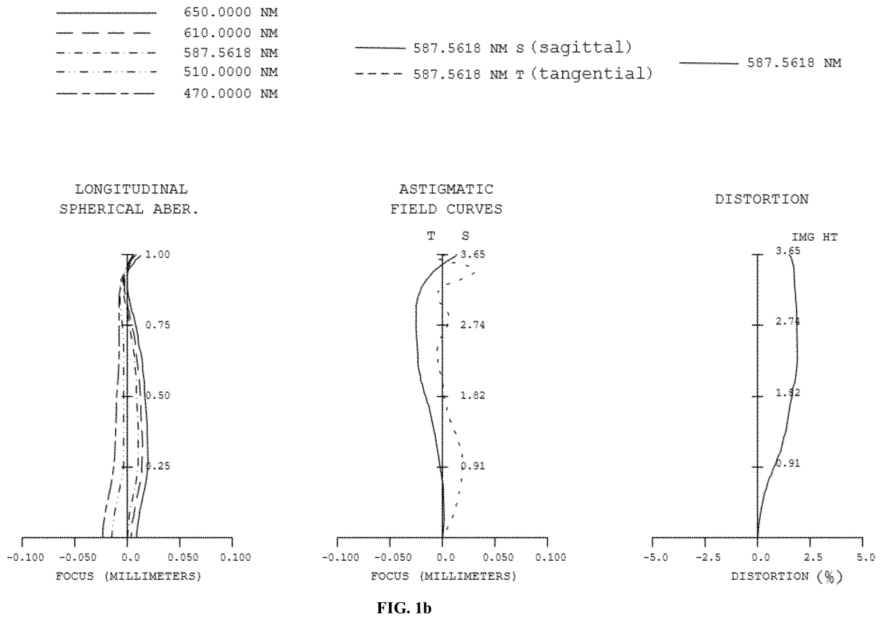

Referring to FIG. 1a and FIG. 1b, the optical system in this implementation includes the first lens L1, the second lens L2, the third lens L3, the fourth lens L4, the fifth lens L5, the sixth lens L6, and the seventh lens L7 which are sequentially arranged from the object side to the image side along the optical axis of the optical system.

The first lens L1 has a positive refractive power. The object-side surface S1 of the first lens L1 is convex near the optical axis and is convex at a circumference. The image-side surface S2 of the first lens L1 is concave near the optical axis and is concave at a circumference.

The second lens L2 has a negative refractive power. The object-side surface S3 of the second lens L2 is convex near the optical axis and is convex at a circumference. The image-side surface S4 of the second lens L2 is concave near the optical axis and is concave at a circumference.

The third lens L3 has a negative refractive power. The object-side surface S5 of the third lens L3 is convex near the optical axis and is concave at a circumference. The image-side surface S6 of the third lens L3 is concave near the optical axis and is convex at a circumference.

The fourth lens L4 has a positive refractive power. The object-side surface S7 of the fourth lens L4 is convex near the optical axis and is convex at a circumference. The image-side surface S8 of the fourth lens L4 is convex near the optical axis and is convex at a circumference.

The fifth lens L5 has a negative refractive power. The object-side surface S9 of the fifth lens L5 is convex near the optical axis and is concave at a circumference. The image-side surface S10 of the fifth lens L5 is concave near the optical axis and is convex at a circumference.

The sixth lens L6 has a positive refractive power. The object-side surface S11 of the sixth lens L6 is convex near the optical axis and is concave at a circumference. The image-side surface S12 of the sixth lens L6 is convex near the optical axis and is convex at a circumference.

The seventh lens L7 has a negative refractive power. The object-side surface S13 of the seventh lens L7 is concave near the optical axis and is convex at a circumference. The image-side surface S14 of the seventh lens L7 is concave near the optical axis and is convex at a circumference.

In an implementation, each lens of the first to seventh lenses (L1 to L8) is made of plastic.

In addition, the optical system further includes an aperture stop (STO), an infrared cut-off filter L8, and the imaging plane S17. The aperture stop STO is arranged at a side of the first lens L1 away from the second lens L2 to control the amount of light entering the lens. In other implementations, the aperture stop STO can also be arranged between two adjacent lenses, or on another lens. The infrared cut-off filter L8 is arranged at an image side of the seventh lens L7 and has an object-side surface S15 and an image-side surface S16. The infrared cut-off filter L8 is used to filter out infrared light so that the light entering the imaging plane S17 is visible light, and the wavelength of visible light is 380 nm-780 nm. The infrared cut-off filter L8 is made of glass and can be coated thereon. The imaging plane S17 is a plane where light reflected by the subject travels through the optical system to form an image.

Table 1a illustrates characteristics of the optical system in this implementation. Each of Y radius, thickness, and focal length is in units of millimeter (mm).

TABLE 1a
Optical system illustrated in FIG. 1a
f = 3.58 mm, FNO = 1.98, FOV = 90.29°

| Surface | Surface | | | | | Refractive | Abbe | Focal |
|---|---|---|---|---|---|---|---|---|
| Number | Name | Shape | Y Radius | Thickness | Material | Index | Number | length |
| Object | | Spherical | Infinity | Infinity | | | | |
| number | | | | | | | | |
| STO | | Spherical | Infinity | −0.223 | | | | |
| S1 | First lens | Aspherical | 1.942 | 0.519 | Plastic | 1.54 | 56.1 | 5.68 |
| S2 | | Aspherical | 4.735 | 0.100 | | | | |
| S3 | Second lens | Aspherical | 3.588 | 0.230 | Plastic | 1.67 | 19.2 | −24.57 |
| S4 | | Aspherical | 2.871 | 0.210 | | | | |
| S5 | Third lens | Aspherical | 4.778 | 0.259 | Plastic | 1.64 | 23.5 | −62.76 |
| S6 | | Aspherical | 4.179 | 0.069 | | | | |
| S7 | Fourth lens | Aspherical | 11.541 | 0.613 | Plastic | 1.54 | 56.1 | 15.11 |
| S8 | | Aspherical | −28.056 | 0.100 | | | | |
| S9 | Fifth lens | Aspherical | 5.974 | 0.290 | Plastic | 1.67 | 19.2 | −15.70 |
| S10 | | Aspherical | 3.739 | 0.157 | | | | |
| S11 | Sixth lens | Aspherical | 3.331 | 0.720 | Plastic | 1.54 | 56.1 | 1.92 |
| S12 | | Aspherical | −1.402 | 0.292 | | | | |
| S13 | Seventh lens | Aspherical | −3.848 | 0.360 | Plastic | 1.53 | 55.8 | −1.82 |
| S14 | | Aspherical | 1.35 | 0.564 | | | | |
| S15 | Infrared cut- | Spherical | Infinity | 0.210 | Glass | 1.52 | 64.2 | |
| S16 | off filter | Spherical | Infinity | 0.269 | | | | |
| S17 | | Spherical | Infinity | 0.000 | | | | |

Note:
The reference wavelength is 587.5618 nm

f represents the focal length of the optical system. FNO represents the F-number of the optical system. FOV is a field angle of the optical system.

In this implementation, the object-side surface and the image-side surface of each of the first to seventh lenses (L1, L2, L3, L4, L5, L6, L7) are aspherical. A surface shape of each aspherical lens can be defined but not limited to the following aspherical formula:

$$x = \frac{{ch}^{2}}{1 + \sqrt{1 - ( k + 1 ) {c}^{2} {h}^{2}}} + \sum {Aih}^{i}$$

x represents a distance (sag) along the optical axis from a vertex of the aspherical surface to a position on the aspherical surface at a height h. c represents the paraxial curvature of the aspherical surface, and is the inverse of the Y radius (that is, c=1/R, where R represents the Y radius in the Table 1a). k represents the conic coefficient. Ai represents the i-th order correction coefficient of the aspherical surface. Table 1b shows higher-order coefficients A4, A6, A8, A10, A12, A14, A16, A18, and A20 of each of aspherical lens surfaces S1 to S14 of the optical system illustrated in FIG. 1a.

TABLE 1b
Optical system of FIG. 1a
Aspherical coefficients

| Surface | | | | | | | |
|---|---|---|---|---|---|---|---|
| Number | S1 | S2 | S3 | S4 | S5 | S6 | S7 |
| K | 6.31E−02 | −8.28E+00 | −2.72E+01 | −2.06E+00 | −6.55E+01 | −3.01E+01 | 6.53E+01 |
| A4 | −8.15E−04 | −4.11E−02 | −4.23E−02 | −6.40E−02 | −2.26E−03 | −8.77E−02 | −1.64E−01 |
| A6 | 4.58E−02 | −1.58E−02 | 5.66E−02 | 1.12E−01 | 2.32E−01 | 5.74E−01 | 5.22E−01 |
| A8 | −3.22E−01 | 3.17E−01 | −4.23E−01 | −5.48E−01 | −2.09E+00 | −2.06E+00 | −1.02E+00 |
| A10 | 1.42E+00 | −1.30E+00 | 1.84E+00 | 2.22E+00 | 7.72E+00 | 4.43E+00 | 1.05E+00 |
| A12 | −3.73E+00 | 3.34E+00 | −4.48E+00 | −5.50E+00 | −1.75E+01 | −6.38E+00 | −2.24E−01 |
| A14 | 5.89E+00 | −5.52E+00 | 6.36E+00 | 8.31E+00 | 2.48E+01 | 6.16E+00 | −6.87E−01 |
| A16 | −5.45E+00 | 5.37E+00 | −5.50E+00 | −7.69E+00 | −2.15E+01 | −3.86E+00 | 7.61E−01 |
| A18 | 2.70E+00 | −2.77E+00 | 2.69E+00 | 4.00E+00 | 1.04E+01 | 1.41E+00 | −3.23E−01 |
| A20 | −5.41E−01 | 5.85E−01 | −5.59E−01 | −8.82E−01 | −2.11E+00 | −2.26E−01 | 5.04E−02 |
| Surface | | | | | | | |
| Number | S8 | S9 | S10 | S11 | S12 | S13 | S14 |
| K | −9.90E+01 | −5.07E+01 | −2.23E+01 | −3.12E+01 | −6.89E+00 | −1.08E+01 | −6.72E+00 |
| A4 | −9.47E−02 | 1.94E−02 | −3.15E−02 | −4.14E−02 | −7.10E−02 | −5.40E−02 | −4.94E−02 |
| A6 | −2.47E−01 | −3.53E−01 | −9.87E−02 | 5.40E−02 | 1.67E−01 | −2.15E−02 | 6.83E−03 |
| A8 | 1.18E+00 | 1.08E+00 | 2.99E−01 | −7.55E−02 | −1.71E−01 | 3.08E−02 | 4.51E−03 |
| A10 | −2.66E+00 | −1.79E+00 | −3.99E−01 | 5.70E−02 | 1.08E−01 | −1.20E−02 | −2.91E−03 |
| A12 | 3.45E+00 | 1.76E+00 | 2.94E−01 | −3.51E−02 | −4.48E−02 | 2.57E−03 | 7.81E−04 |
| A14 | −2.76E+00 | −1.08E+00 | −1.29E−01 | 1.72E−02 | 1.24E−02 | −3.38E−04 | −1.18E−04 |
| A16 | 1.37E+00 | 4.12E−01 | 3.39E−02 | −5.72E−03 | −2.17E−03 | 2.75E−05 | 1.04E−05 |
| A18 | −3.79E−01 | −8.95E−02 | −4.87E−03 | 1.11E−03 | 2.16E−04 | −1.28E−06 | −4.92E−07 |
| A20 | 4.52E−02 | 8.43E−03 | 2.96E−04 | −9.06E−05 | −9.27E−06 | 2.60E−08 | 9.68E−09 |

FIG. 1b illustrates a longitudinal spherical aberration curve, an astigmatic field curve, and a distortion curve of the optical system of FIG. 1a. The longitudinal spherical aberration curve represents a focus deviation of each of light rays with different wavelengths after passing through each lens of the optical system. The astigmatic field curve represents tangential image surface curvature and sagittal image surface curvature. The distortion curve represents magnitudes of distortions corresponding to different field angles. According to the longitudinal spherical aberration curves illustrated in FIG. 1b, the longitudinal spherical aberration of the optical system for light rays with wavelengths of 470.0000 nm, 510.0000 nm, 587.5618 nm, 610.0000 nm, and 650.0000 nm is ranged from −0.025 mm to 0.01 mm. According to the astigmatic field curves illustrated in FIG. 1b, the astigmatism of the optical system for a light ray with the wavelength of 587.5618 nm in the tangential and sagittal directions is ranged from −0.03 mm to 0.03 mm. According to the distortion curves illustrated in FIG. 1b, the distortion of the optical system for the light ray with the wavelength of 587.5618 nm is ranged from 0.0% and 2.0%. As illustrated in FIG. 1b, it is clear that the optical system of FIG. 1a can achieve good imaging quality.

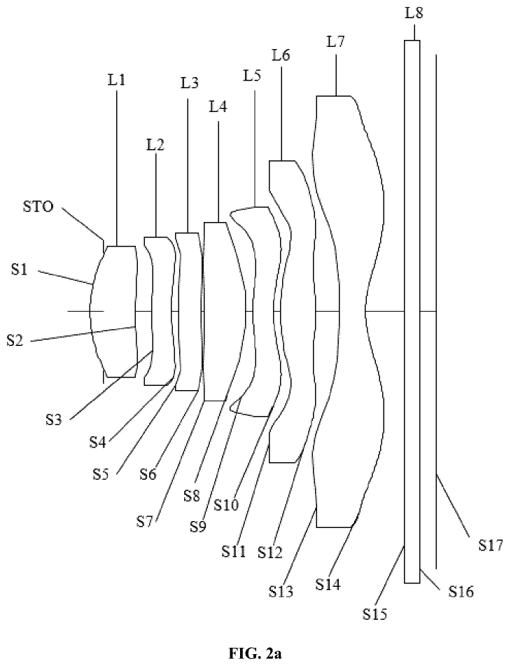

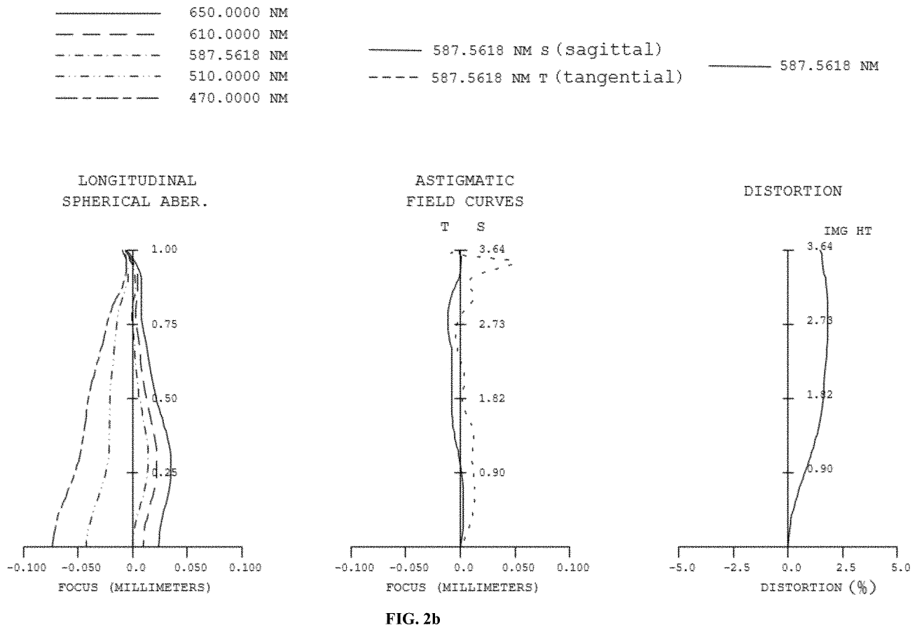

Referring to FIG. 2a and FIG. 2b, the optical system in this implementation includes the first lens L1, the second lens L2, the third lens L3, the fourth lens L4, the fifth lens L5, the sixth lens L6, and the seventh lens L7 which are sequentially arranged from the object side to the image side along the optical axis of the optical system.

The first lens L1 has a positive refractive power. The object-side surface S1 of the first lens L1 is convex near the optical axis and is convex at a circumference. The image-side surface S2 of the first lens L1 is concave near the optical axis and is convex at a circumference.

The second lens L2 has a negative refractive power. The object-side surface S3 of the second lens L2 is convex near the optical axis and is concave at a circumference. The image-side surface S4 of the second lens L2 is concave near the optical axis and is convex at a circumference.

The third lens L3 has a positive refractive power. The object-side surface S5 of the third lens L3 is convex near the optical axis and is concave at a circumference. The image-side surface S6 of the third lens L3 is concave near the optical axis and is convex at a circumference.

The fourth lens L4 has a negative refractive power. The object-side surface S7 of the fourth lens L4 is concave near the optical axis and is concave at a circumference. The image-side surface S8 of the fourth lens L4 is concave near the optical axis and is convex at a circumference.

The fifth lens L5 has a positive refractive power. The object-side surface S9 of the fifth lens L5 is convex near the optical axis and is concave at a circumference. The image-side surface S10 of the fifth lens L5 is concave near the optical axis and is convex at a circumference.

The sixth lens L6 has a positive refractive power. The object-side surface S11 of the sixth lens L6 is convex near the optical axis and is concave at a circumference. The image-side surface S12 of the sixth lens L6 is convex near the optical axis and is convex at a circumference.

The seventh lens L7 has a negative refractive power. The object-side surface S13 of the seventh lens L7 is concave near the optical axis and is convex at a circumference. The image-side surface S14 of the seventh lens L7 is concave near the optical axis and is convex at a circumference.

The other structures of the optical system of FIG. 2a are identical with the optical system of FIG. 1a, reference can be made to the optical system of FIG. 1a.

Table 2a illustrates characteristics of the optical system in this implementation. Each of Y radius, thickness, and focal length is in units of millimeter (mm).

TABLE 2a
Optical system of FIG. 2a
f = 3.55 mm, FNO = 2.02, FOV = 90.60°

| Surface | Surface | | | | | Refractive | Abbe | Focal |
|---|---|---|---|---|---|---|---|---|
| Number | Name | Shape | Y Radius | Thickness | Material | Index | Number | length |
| Object | | Spherical | Infinity | Infinity | | | | |
| number | | | | | | | | |
| STO | | Spherical | Infinity | −0.180 | | | | |
| S1 | First lens | Aspherical | 1.932 | 0.632 | Plastic | 1.54 | 56.1 | 5.22 |
| S2 | | Aspherical | 5.347 | 0.227 | | | | |
| S3 | Second lens | Aspherical | 4.96 | 0.276 | Plastic | 1.67 | 19.2 | −24.06 |
| S4 | | Aspherical | 3.71 | 0.091 | | | | |
| S5 | Third lens | Aspherical | 10.916 | 0.322 | Plastic | 1.67 | 19.2 | 58.25 |
| S6 | | Aspherical | 14.962 | 0.041 | | | | |
| S7 | Fourth lens | Aspherical | −30.874 | 0.577 | Plastic | 1.53 | 55.8 | −32.65 |
| S8 | | Aspherical | 40.479 | 0.100 | | | | |
| S9 | Fifth lens | Aspherical | 1.747 | 0.290 | Plastic | 1.67 | 19.2 | 44.56 |
| S10 | | Aspherical | 1.732 | 0.100 | | | | |
| S11 | Sixth lens | Aspherical | 3.5 | 0.491 | Plastic | 1.64 | 23.5 | 2.44 |
| S12 | | Aspherical | −2.66 | 0.328 | | | | |
| S13 | Seventh lens | Aspherical | −12.421 | 0.360 | Plastic | 1.53 | 55.8 | −2.26 |
| S14 | | Aspherical | 1.35 | 0.542 | | | | |
| S15 | Infrared cut- | Spherical | Infinity | 0.210 | Glass | 1.52 | 64.2 | |
| S16 | off filter | Spherical | Infinity | 0.230 | | | | |
| S17 | | Spherical | Infinity | 0.000 | | | | |

Note:
The reference wavelength is 587.5618 nm

Each parameter in Table 2a represents the same meaning as that in the optical system of FIG. 1a.

Table 2b shows higher-order coefficients that can be used for each aspherical lens surface of the optical system of FIG. 2a, where a shape of each aspherical lens surface can be defined by the formula given in the optical system of FIG. 1a.

TABLE 2b
Optical system of FIG. 2a
Aspherical coefficients

| Surface | | | | | | | |
|---|---|---|---|---|---|---|---|
| Number | S1 | S2 | S3 | S4 | S5 | S6 | S7 |
| K | −6.67E−01 | −9.07E+01 | −9.90E+01 | −1.25E+01 | 5.78E+01 | 9.90E+01 | −9.90E+01 |
| A4 | 5.17E−03 | 1.58E−02 | −6.50E−02 | 3.47E−03 | 1.15E−01 | −1.06E−03 | −1.45E−01 |
| A6 | −1.22E−02 | −2.50E−01 | −1.26E−01 | −3.74E−01 | −5.41E−01 | 7.76E−01 | 1.68E+00 |
| A8 | 4.34E−02 | 9.11E−01 | −5.40E−01 | 1.23E+00 | 1.26E+00 | −4.59E+00 | −7.05E+00 |
| A10 | −8.16E−02 | −3.16E+00 | 3.14E+00 | −2.99E+00 | −1.29E+00 | 1.21E+01 | 1.54E+01 |
| A12 | −9.22E−02 | 7.30E+00 | −8.42E+00 | 4.93E+00 | −1.07E+00 | −1.88E+01 | −2.00E+01 |
| A14 | 5.21E−01 | −1.09E+01 | 1.35E+01 | −5.28E+00 | 4.45E+00 | 1.83E+01 | 1.63E+01 |
| A16 | −7.43E−01 | 1.00E+01 | −1.30E+01 | 3.48E+00 | −5.06E+00 | −1.10E+01 | −8.17E+00 |
| A18 | 4.20E−01 | −5.18E+00 | 6.99E+00 | −1.34E+00 | 2.62E+00 | 3.76E+00 | 2.33E+00 |
| A20 | −6.81E−02 | 1.17E+00 | −1.61E+00 | 2.38E−01 | −5.23E−01 | −5.59E−01 | −2.90E−01 |
| Surface | | | | | | | |
| Number | S8 | S9 | S10 | S11 | S12 | S13 | S14 |
| K | −9.90E+01 | −2.36E+01 | −1.90E+01 | −6.89E+00 | −1.35E+01 | −2.35E+01 | −4.94E+00 |
| A4 | −1.05E+00 | −5.69E−01 | −5.55E−03 | 9.54E−02 | 1.90E−01 | −3.67E−02 | −9.79E−02 |
| A6 | 3.86E+00 | 1.97E+00 | 4.03E−02 | −8.58E−02 | −4.12E−03 | −1.26E−03 | 5.27E−02 |
| A8 | −9.91E+00 | −4.40E+00 | −3.19E−01 | −9.36E−02 | −1.16E−01 | −3.21E−03 | −2.39E−02 |
| A10 | 1.64E+01 | 5.80E+00 | 4.16E−01 | 2.32E−01 | 7.07E−02 | 5.73E−03 | 7.53E−03 |
| A12 | −1.79E+01 | −4.77E+00 | −2.56E−01 | −2.47E−01 | −1.72E−02 | −2.32E−03 | −1.52E−03 |
| A14 | 1.28E+01 | 2.50E+00 | 7.96E−02 | 1.44E−01 | 1.08E−03 | 4.55E−04 | 1.92E−04 |
| A16 | −5.76E+00 | −8.21E−01 | −9.34E−03 | −4.69E−02 | 3.15E−04 | −4.85E−05 | −1.44E−05 |
| A18 | 1.47E+00 | 1.53E−01 | −6.75E−04 | 7.93E−03 | −6.58E−05 | 2.72E−06 | 5.82E−07 |
| A20 | −1.60E−01 | −1.20E−02 | 1.83E−04 | −5.48E−04 | 3.79E−06 | −6.30E−08 | −9.76E−09 |

FIG. 2b illustrates a longitudinal spherical aberration curve, an astigmatic field curve, and a distortion curve of the optical system of FIG. 2a. According to the longitudinal spherical aberration curves illustrated in FIG. 2b, the longitudinal spherical aberration of the optical system for light rays with wavelengths of 470.0000 nm, 510.0000 nm, 587.5618 nm, 610.0000 nm, and 650.0000 nm is ranged from −0.075 mm to 0.03 mm. According to the astigmatic field curves illustrated in FIG. 2b, the astigmatism of the optical system for a light ray with the wavelength of 587.5618 nm in the tangential and sagittal directions is ranged from −0.01 mm to 0.04 mm. According to the distortion curves illustrated in FIG. 2b, the distortion of the optical system for the light ray with the wavelength of 587.5618 nm is ranged from 0.0% and 2.0%. As illustrated in FIG. 2b, the optical system of FIG. 2a can achieve good imaging quality.

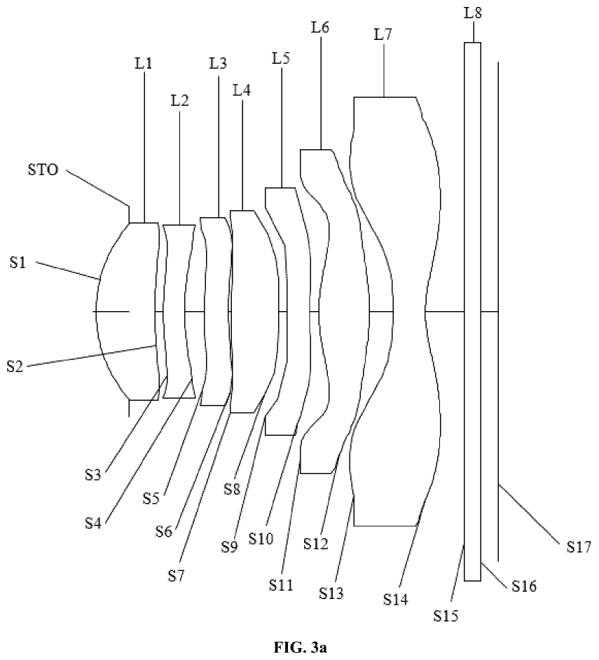

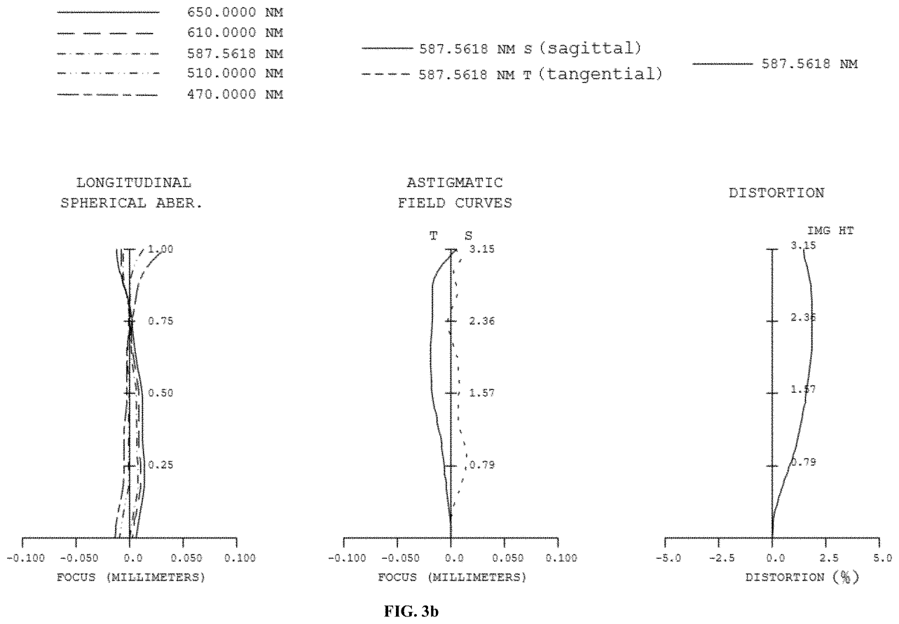

Referring to FIG. 3a and FIG. 3b, the optical system in this implementation includes the first lens L1, the second lens L2, the third lens L3, the fourth lens L4, the fifth lens L5, the sixth lens L6, and the seventh lens L7 which are sequentially arranged from the object side to the image side along the optical axis of the optical system.

The first lens L1 has a positive refractive power. The object-side surface S1 of the first lens L1 is convex near the optical axis and is convex at a circumference. The image-side surface S2 of the first lens L1 is concave near the optical axis and is convex at a circumference.

The second lens L2 has a negative refractive power. The object-side surface S3 of the second lens L2 is convex near the optical axis and is convex at a circumference. The image-side surface S4 of the second lens L2 is concave near the optical axis and is concave at a circumference.

The third lens L3 has a negative refractive power. The object-side surface S5 of the third lens L3 is convex near the optical axis and is concave at a circumference. The image-side surface S6 of the third lens L3 is concave near the optical axis and is convex at a circumference.

The fourth lens L4 has a positive refractive power. The object-side surface S7 of the fourth lens L4 is convex near the optical axis and is concave at a circumference. The image-side surface S8 of the fourth lens L4 is convex near the optical axis and is convex at a circumference.

The fifth lens L5 has a negative refractive power. The object-side surface S9 of the fifth lens L5 is concave near the optical axis and is concave at a circumference. The image-side surface S10 of the fifth lens L5 is concave near the optical axis and is convex at a circumference.

The sixth lens L6 has a positive refractive power. The object-side surface S11 of the sixth lens L6 is convex near the optical axis and is concave at a circumference. The image-side surface S12 of the sixth lens L6 is convex near the optical axis and is convex at a circumference.

The seventh lens L7 has a negative refractive power. The object-side surface S13 of the seventh lens L7 is concave near the optical axis and is concave at a circumference. The image-side surface S14 of the seventh lens L7 is concave near the optical axis and is convex at a circumference.

The other structures of the optical system of FIG. 3a are identical with the optical system of FIG. 1a, reference can be made to the optical system of FIG. 1a.

Table 3a illustrates characteristics of the optical system in this implementation. Each of Y radius, thickness, and focal length is in units of millimeter (mm).

TABLE 3a
Optical system of FIG. 3a
f = 3.67 mm, FNO = 1.58, FOV = 80.40°

| Surface | Surface | | | | | Refractive | Abbe | Focal |
|---|---|---|---|---|---|---|---|---|
| Number | Name | Shape | Y Radius | Thickness | Material | Index | Number | length |
| Object | | Spherical | Infinity | Infinity | | | | |
| number | | | | | | | | |
| STO | | Spherical | Infinity | −0.413 | | | | |
| S1 | First lens | Aspherical | 1.877 | 0.723 | Plastic | 1.54 | 56.1 | 5.37 |
| S2 | | Aspherical | 4.54 | 0.110 | | | | |
| S3 | Second lens | Aspherical | 3.287 | 0.260 | Plastic | 1.67 | 19.2 | −33.07 |
| S4 | | Aspherical | 2.772 | 0.249 | | | | |
| S5 | Third lens | Aspherical | 6.833 | 0.295 | Plastic | 1.67 | 19.2 | −43.30 |
| S6 | | Aspherical | 5.436 | 0.034 | | | | |
| S7 | Fourth lens | Aspherical | 9.236 | 0.594 | Plastic | 1.54 | 56.1 | 10.25 |
| S8 | | Aspherical | −13.76 | 0.100 | | | | |
| S9 | Fifth lens | Aspherical | −128.372 | 0.280 | Plastic | 1.67 | 19.2 | −6.72 |
| S10 | | Aspherical | 4.684 | 0.110 | | | | |
| S11 | Sixth lens | Aspherical | 1.87 | 0.633 | Plastic | 1.54 | 56.1 | 2.11 |
| S12 | | Aspherical | −2.626 | 0.290 | | | | |
| S13 | Seventh lens | Aspherical | −4.61 | 0.396 | Plastic | 1.53 | 55.8 | −2.18 |
| S14 | | Aspherical | 1.608 | 0.483 | | | | |
| S15 | Infrared cut- | Spherical | Infinity | 0.210 | Glass | 1.52 | 64.2 | |
| S16 | off filter | Spherical | Infinity | 0.214 | | | | |
| S17 | | Spherical | Infinity | 0.000 | | | | |

Note:
The reference wavelength is 587.5618 nm

Each parameter in Table 3a represents the same meaning as that in the optical system of FIG. 1a.

Table 3b shows higher-order coefficients that can be used for each aspherical lens surface of the optical system of FIG. 3a, where a shape of each aspherical lens surface can be defined by the formula given in the optical system of FIG. 1a.

TABLE 3b
Optical system of FIG. 3a
Aspherical coefficients

| Surface | | | | | | | |
|---|---|---|---|---|---|---|---|
| Number | S1 | S2 | S3 | S4 | S5 | S6 | S7 |
| K | 2.68E−02 | −2.99E+01 | −7.96E+01 | −5.89E+00 | −7.82E+01 | −2.06E+01 | 2.45E+01 |
| A4 | −3.32E−03 | −4.41E−02 | 9.40E−02 | −7.30E−02 | 2.19E−02 | 7.69E−03 | −4.87E−02 |
| A6 | 3.50E−02 | −9.26E−02 | −7.49E−01 | 2.07E−02 | −2.25E−01 | −1.69E−01 | −1.08E−01 |
| A8 | −1.51E−01 | 8.03E−01 | 2.36E+00 | −1.01E−01 | 8.53E−01 | 6.79E−01 | 5.79E−01 |
| A10 | 4.24E−01 | −2.57E+00 | −5.07E+00 | 7.31E−01 | −2.80E+00 | −1.67E+00 | −1.15E+00 |
| A12 | −7.19E−01 | 4.90E+00 | 7.72E+00 | −1.94E+00 | 5.51E+00 | 2.27E+00 | 1.03E+00 |
| A14 | 7.52E−01 | −5.81E+00 | −8.19E+00 | 2.74E+00 | −6.52E+00 | −1.87E+00 | −2.91E−01 |
| A16 | −4.70E−01 | 4.22E+00 | 5.69E+00 | −2.25E+00 | 4.45E+00 | 9.12E−01 | −1.84E−01 |
| A18 | 1.62E−01 | −1.72E+00 | −2.31E+00 | 1.01E+00 | −1.58E+00 | −2.35E−01 | 1.55E−01 |
| A20 | −2.36E−02 | 3.00E−01 | 4.12E−01 | −1.91E−01 | 2.24E−01 | 2.31E−02 | −3.27E−02 |
| Surface | | | | | | | |
| Number | S8 | S9 | S10 | S11 | S12 | S13 | S14 |
| K | −7.98E+01 | 9.90E+01 | −9.90E+01 | −1.36E+01 | −9.39E+00 | −5.77E+00 | −7.90E+00 |
| A4 | 5.74E−02 | 9.50E−02 | −1.86E−01 | −8.17E−02 | 7.71E−02 | −1.98E−01 | −1.08E−01 |
| A6 | −6.38E−01 | −5.62E−01 | 2.55E−01 | 1.30E−01 | −6.97E−02 | 1.28E−01 | 7.23E−02 |
| A8 | 1.28E+00 | 1.19E+00 | −3.60E−01 | −1.43E−01 | 8.36E−02 | −5.79E−02 | −3.54E−02 |
| A10 | −1.79E+00 | −1.89E+00 | 3.65E−01 | 5.86E−02 | −6.47E−02 | 2.93E−02 | 1.22E−02 |
| A12 | 1.76E+00 | 2.10E+00 | −2.64E−01 | 2.04E−02 | 2.17E−02 | −1.18E−02 | −2.96E−03 |
| A14 | −1.12E+00 | −1.48E+00 | 1.40E−01 | −4.27E−02 | −1.73E−03 | 2.99E−03 | 4.87E−04 |
| A16 | 4.51E−01 | 6.37E−01 | −5.08E−02 | 2.25E−02 | −6.91E−04 | −4.51E−04 | −5.21E−05 |
| A18 | −1.10E−01 | −1.53E−01 | 1.07E−02 | −5.08E−03 | 1.73E−04 | 3.72E−05 | 3.25E−06 |
| A20 | 1.29E−02 | 1.58E−02 | −9.51E−04 | 4.24E−04 | −1.17E−05 | −1.30E−06 | −8.90E−08 |

FIG. 3b illustrates a longitudinal spherical aberration curve, an astigmatic field curve, and a distortion curve of the optical system of FIG. 3a. According to the longitudinal spherical aberration curves illustrated in FIG. 3b, the longitudinal spherical aberration of the optical system for light rays with wavelengths of 470.0000 nm, 510.0000 nm, 587.5618 nm, 610.0000 nm, and 650.0000 nm is ranged from −0.02 mm to 0.02 mm. According to the astigmatic field curves illustrated in FIG. 3b, the astigmatism of the optical system for a light ray with the wavelength of 587.5618 nm in the tangential and sagittal directions is ranged from −0.02 mm to 0.02 mm. According to the distortion curves illustrated in FIG. 3b, the distortion of the optical system for the light ray with the wavelength of 587.5618 nm is ranged from 0.0% and 2.0%. As illustrated in FIG. 3b, the optical system of FIG. 3a can achieve good imaging quality.

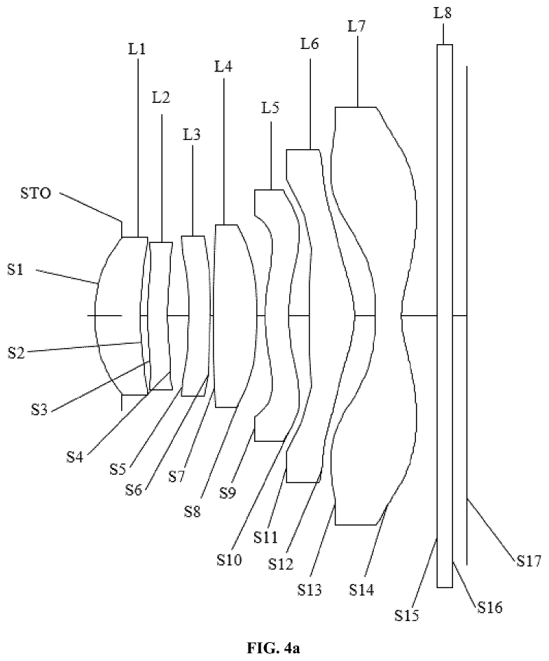

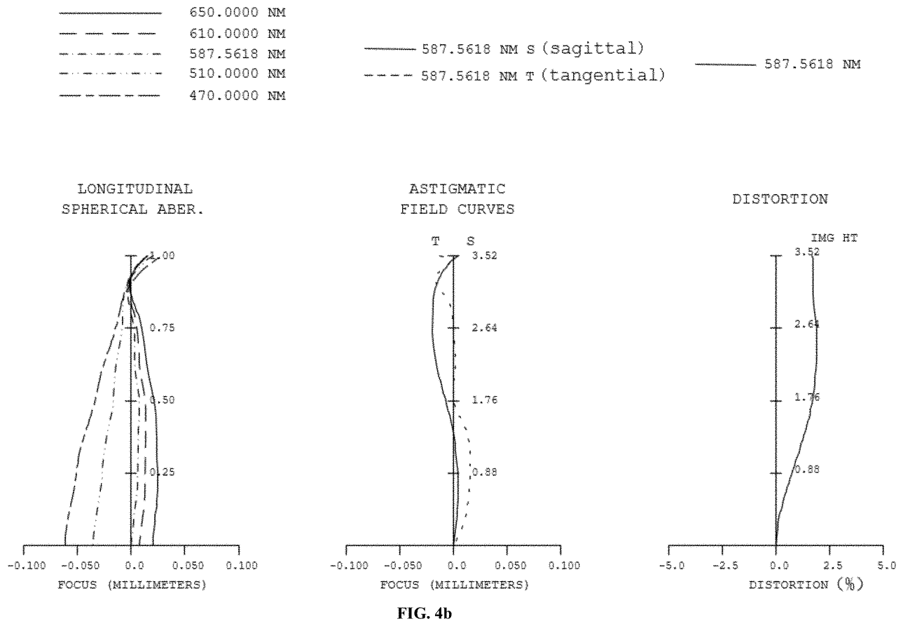

Referring to FIG. 4a and FIG. 4b, the optical system in this implementation includes the first lens L1, the second lens L2, the third lens L3, the fourth lens L4, the fifth lens L5, the sixth lens L6, and the seventh lens L7 which are sequentially arranged from the object side to the image side along the optical axis of the optical system.

The first lens L1 has a positive refractive power. The object-side surface S1 of the first lens L1 is convex near the optical axis and is convex at a circumference. The image-side surface S2 of the first lens L1 is concave near the optical axis and is concave at a circumference.

The second lens L2 has a positive refractive power. The object-side surface S3 of the second lens L2 is convex near the optical axis and is convex at a circumference. The image-side surface S4 of the second lens L2 is concave near the optical axis and is concave at a circumference.

The third lens L3 has a negative refractive power. The object-side surface S5 of the third lens L3 is concave near the optical axis and is concave at a circumference. The image-side surface S6 of the third lens L3 is convex near the optical axis and is convex at a circumference.

The fourth lens L4 has a positive refractive power. The object-side surface S7 of the fourth lens L4 is convex near the optical axis and is convex at a circumference. The image-side surface S8 of the fourth lens L4 is convex near the optical axis and is convex at a circumference.

The fifth lens L5 has a positive refractive power. The object-side surface S9 of the fifth lens L5 is convex near the optical axis and is concave at a circumference. The image-side surface S10 of the fifth lens L5 is concave near the optical axis and is convex at a circumference.

The sixth lens L6 has a positive refractive power. The object-side surface S11 of the sixth lens L6 is concave near the optical axis and is concave at a circumference. The image-side surface S12 of the sixth lens L6 is convex near the optical axis and is convex at a circumference.

The seventh lens L7 has a negative refractive power. The object-side surface S13 of the seventh lens L7 is concave near the optical axis and is convex at a circumference. The image-side surface S14 of the seventh lens L7 is concave near the optical axis and is convex at a circumference.

The other structures of the optical system of the optical system of FIG. 4a are identical with the optical system of FIG. 1a, reference can be made to the optical system of FIG. 1a.

Table 4a illustrates characteristics of the optical system in this implementation. Each of Y radius, thickness, and focal length is in units of millimeter (mm).

TABLE 4a
Optical system of FIG. 4a
f = 3.82 mm, FNO = 1.65, FOV = 84.40°

| Surface | Surface | | | | | Refractive | Abbe | Focal |
|---|---|---|---|---|---|---|---|---|
| Number | Name | Shape | Y Radius | Thickness | Material | Index | Number | length |
| Object | | Spherical | Infinity | Infinity | | | | |
| number | | | | | | | | |
| STO | | Spherical | Infinity | −0.382 | | | | |
| S1 | First lens | Aspherical | 2.051 | 0.641 | Plastic | 1.54 | 56.1 | 6.73 |
| S2 | | Aspherical | 4.145 | 0.095 | | | | |
| S3 | Second lens | Aspherical | 3.59 | 0.280 | Plastic | 1.67 | 19.2 | 30.67 |
| S4 | | Aspherical | 4.212 | 0.293 | | | | |
| S5 | Third lens | Aspherical | −10.595 | 0.300 | Plastic | 1.65 | 21.5 | −25.51 |
| S6 | | Aspherical | −29.587 | 0.050 | | | | |
| S7 | Fourth lens | Aspherical | 21.631 | 0.598 | Plastic | 1.54 | 56.1 | 15.18 |
| S8 | | Aspherical | −13.227 | 0.124 | | | | |
| S9 | Fifth lens | Aspherical | 2.755 | 0.330 | Plastic | 1.67 | 19.2 | 19.18 |
| S10 | | Aspherical | 3.337 | 0.280 | | | | |
| S11 | Sixth lens | Aspherical | −37.864 | 0.632 | Plastic | 1.54 | 56.1 | 2.68 |
| S12 | | Aspherical | −1.41 | 0.298 | | | | |
| S13 | Seventh lens | Aspherical | −3.564 | 0.360 | Plastic | 1.53 | 55.8 | −1.82 |
| S14 | | Aspherical | 1.387 | 0.495 | | | | |
| S15 | Infrared cut- | Spherical | Infinity | 0.210 | Glass | 1.52 | 64.2 | |
| S16 | off filter | Spherical | Infinity | 0.206 | | | | |
| S17 | | Spherical | Infinity | 0.000 | | | | |

Note:
The reference wavelength is 587.5618 nm

Each parameter in Table 4a represents the same meaning as that in the optical system of FIG. 1a.

Table 4b shows higher-order coefficients that can be used for each aspherical lens surface of the optical system of FIG. 4a, where a shape of each aspherical lens surface can be defined by the formula given in the optical system of FIG. 1a.

TABLE 4b
Optical system of FIG. 4a
Aspherical coefficients

| Surface | | | | | | | |
|---|---|---|---|---|---|---|---|
| Number | S1 | S2 | S3 | S4 | S5 | S6 | S7 |
| K | 2.59E−01 | −8.92E+00 | −4.05E+01 | −6.83E+00 | −5.22E+01 | 2.03E+01 | 9.90E+01 |
| A4 | 2.04E−03 | −5.03E−02 | −2.29E−02 | −6.87E−02 | −5.45E−02 | −1.08E−01 | −1.41E−01 |
| A6 | 1.13E−03 | −7.40E−02 | −1.54E−01 | 1.13E−02 | 1.67E−01 | 5.07E−01 | 6.54E−01 |
| A8 | −7.25E−02 | 6.16E−01 | 1.81E−01 | −3.18E−01 | −1.00E+00 | −1.19E+00 | −1.48E+00 |
| A10 | 4.08E−01 | −1.84E+00 | 4.90E−01 | 1.50E+00 | 3.10E+00 | 1.41E+00 | 1.99E+00 |
| A12 | −9.70E−01 | 3.24E+00 | −2.40E+00 | −3.51E+00 | −6.17E+00 | −6.23E−01 | −1.68E+00 |
| A14 | 1.26E+00 | −3.52E+00 | 4.46E+00 | 4.74E+00 | 7.96E+00 | −4.71E−01 | 8.55E−01 |
| A16 | −9.24E−01 | 2.36E+00 | −4.38E+00 | −3.67E+00 | −6.40E+00 | 7.68E−01 | −2.40E−01 |
| A18 | 3.60E−01 | −9.32E−01 | 2.22E+00 | 1.48E+00 | 2.90E+00 | −3.86E−01 | 2.84E−02 |
| A20 | −5.78E−02 | 1.75E−01 | −4.53E−01 | −2.19E−01 | −5.58E−01 | 7.10E−02 | −1.19E−04 |
| Surface | | | | | | | |
| Number | S8 | S9 | S10 | S11 | S12 | S13 | S14 |
| K | 3.55E+01 | −2.36E+01 | −1.35E+01 | −9.90E+01 | −7.19E+00 | −6.84E+00 | −9.16E+00 |
| A4 | −1.57E−01 | 7.12E−02 | 1.36E−01 | 1.15E−01 | −2.88E−03 | −1.20E−01 | −7.49E−02 |
| A6 | 2.27E−01 | −2.64E−01 | −3.20E−01 | −9.95E−02 | 5.37E−02 | 5.90E−02 | 3.71E−02 |
| A8 | −4.23E−01 | 3.56E−01 | 3.39E−01 | 4.37E−02 | −2.29E−02 | −2.79E−02 | −1.45E−02 |
| A10 | 7.47E−01 | −3.03E−01 | −2.21E−01 | −2.27E−02 | −1.19E−02 | 1.54E−02 | 4.06E−03 |
| A12 | −1.03E+00 | 1.62E−01 | 8.68E−02 | 1.09E−02 | 1.23E−02 | −5.40E−03 | −7.96E−04 |
| A14 | 9.27E−01 | −5.91E−02 | −1.93E−02 | −4.53E−03 | −4.11E−03 | 1.09E−03 | 1.04E−04 |
| A16 | −5.05E−01 | 1.51E−02 | 1.85E−03 | 1.39E−03 | 6.90E−04 | −1.27E−04 | −8.50E−06 |
| A18 | 1.51E−01 | −2.42E−03 | 5.26E−05 | −2.31E−04 | −5.87E−05 | 7.98E−06 | 3.97E−07 |
| A20 | −1.89E−02 | 1.61E−04 | −1.69E−05 | 1.50E−05 | 2.01E−06 | −2.10E−07 | −8.17E−09 |

FIG. 4b illustrates a longitudinal spherical aberration curve, an astigmatic field curve, and a distortion curve of the optical system of FIG. 4a. According to the longitudinal spherical aberration curves illustrated in FIG. 4b, the longitudinal spherical aberration of the optical system for light rays with wavelengths of 470.0000 nm, 510.0000 nm, 587.5618 nm, 610.0000 nm, and 650.0000 nm is ranged from −0.06 mm to 0.02 mm. According to the astigmatic field curves illustrated in FIG. 4b, the astigmatism of the optical system for a light ray with the wavelength of 587.5618 nm in the tangential and sagittal directions is ranged from −0.02 mm to 0.02 mm. According to the distortion curves illustrated in FIG. 4b, the distortion of the optical system for the light ray with the wavelength of 587.5618 nm is ranged from 0.0% and 2.0%. As illustrated in FIG. 4b, the optical system of FIG. 4a can achieve good imaging quality.

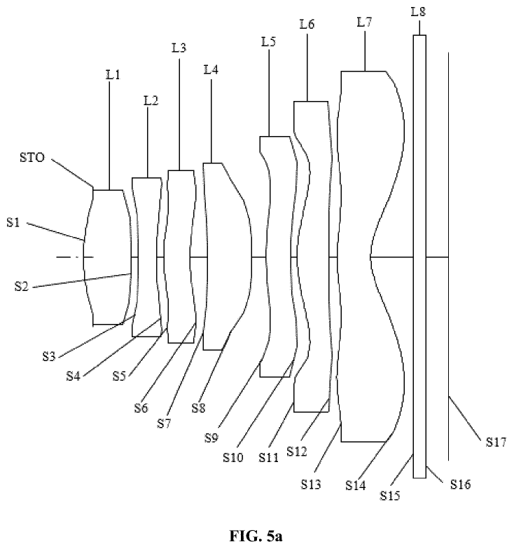

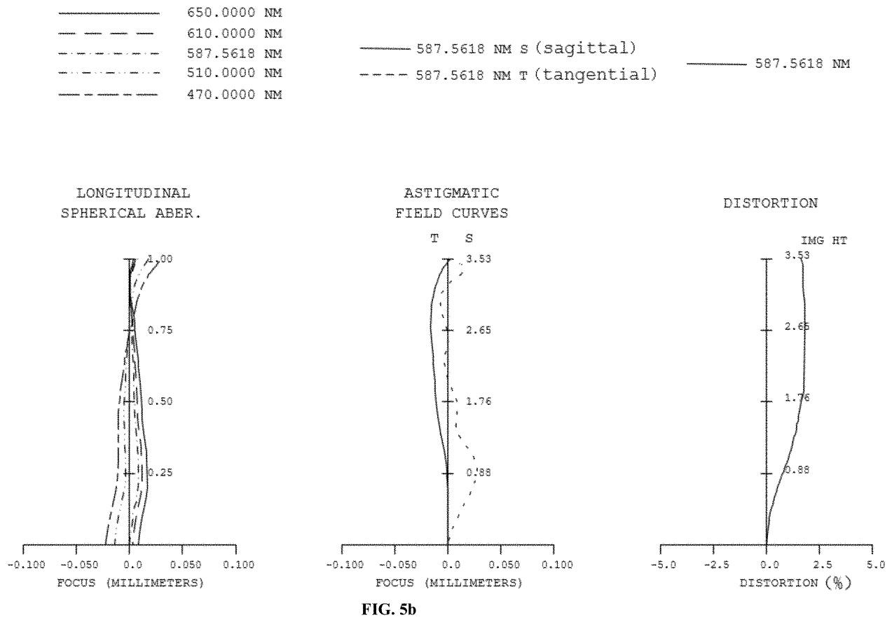

Referring to FIG. 5a and FIG. 5b, the optical system in this implementation includes the first lens L1, the second lens L2, the third lens L3, the fourth lens L4, the fifth lens L5, the sixth lens L6, and the seventh lens L7 which are sequentially arranged from the object side to the image side along the optical axis of the optical system.

The first lens L1 has a positive refractive power. The object-side surface S1 of the first lens L1 is convex near the optical axis and is convex at a circumference. The image-side surface S2 of the first lens L1 is convex near the optical axis and is convex at a circumference.

The second lens L2 has a negative refractive power. The object-side surface S3 of the second lens L2 is concave near the optical axis and is concave at a circumference. The image-side surface S4 of the second lens L2 is concave near the optical axis and is convex at a circumference.

The third lens L3 has a positive refractive power. The object-side surface S5 of the third lens L3 is convex near the optical axis and is convex at a circumference. The image-side surface S6 of the third lens L3 is concave near the optical axis and is concave at a circumference.

The fourth lens L4 has a positive refractive power. The object-side surface S7 of the fourth lens L4 is convex near the optical axis and is convex at a circumference. The image-side surface S8 of the fourth lens L4 is convex near the optical axis and is convex at a circumference.

The fifth lens L5 has a positive refractive power. The object-side surface S9 of the fifth lens L5 is convex near the optical axis and is convex at a circumference. The image-side surface S10 of the fifth lens L5 is concave near the optical axis and is concave at a circumference.

The sixth lens L6 has a positive refractive power. The object-side surface S11 of the sixth lens L6 is convex near the optical axis and is concave at a circumference. The image-side surface S12 of the sixth lens L6 is concave near the optical axis and is convex at a circumference.

The seventh lens L7 has a negative refractive power. The object-side surface S13 of the seventh lens L7 is convex near the optical axis and is convex at a circumference. The image-side surface S14 of the seventh lens L7 is concave near the optical axis and is convex at a circumference.

The other structures of the optical system of FIG. 5a are identical with the optical system of FIG. 1a, reference can be made to the optical system of FIG. 1a.

Table 5a illustrates characteristics of the optical system in this implementation. Each of Y radius, thickness, and focal length is in units of millimeter (mm).

TABLE 5a
Optical system of FIG. 5a
f = 4.08 mm, FNO = 1.95, FOV = 80.80°

| Surface | Surface | | | | | Refractive | Abbe | Focal |
|---|---|---|---|---|---|---|---|---|
| Number | Name | Shape | Y Radius | Thickness | Material | Index | Number | length |
| Object | | Spherical | Infinity | Infinity | | | | |
| number | | | | | | | | |
| STO | | Spherical | Infinity | −0.152 | | | | |
| S1 | First lens | Aspherical | 3.146 | 0.793 | Plastic | 1.54 | 56.1 | 5.15 |
| S2 | | Aspherical | −23.33 | 0.119 | | | | |
| S3 | Second lens | Aspherical | −56.237 | 0.310 | Plastic | 1.67 | 19.2 | −6.76 |
| S4 | | Aspherical | 4.949 | 0.124 | | | | |
| S5 | Third lens | Aspherical | 2.819 | 0.438 | Plastic | 1.67 | 19.2 | 20.57 |
| S6 | | Aspherical | 3.321 | 0.291 | | | | |
| S7 | Fourth lens | Aspherical | 101.398 | 0.750 | Plastic | 1.54 | 56.1 | 24.34 |
| S8 | | Aspherical | −15.197 | 0.249 | | | | |
| S9 | Fifth lens | Aspherical | 8.011 | 0.410 | Plastic | 1.67 | 19.2 | 18.92 |
| S10 | | Aspherical | 21.24 | 0.100 | | | | |
| S11 | Sixth lens | Aspherical | 2.596 | 0.538 | Plastic | 1.54 | 56.1 | 5.12 |
| S12 | | Aspherical | 35.33 | 0.132 | | | | |
| S13 | Seventh lens | Aspherical | 2.59 | 0.565 | Plastic | 1.53 | 55.8 | −4.62 |
| S14 | | Aspherical | 1.168 | 0.713 | | | | |
| S15 | Infrared cut- | Spherical | Infinity | 0.210 | Glass | 1.52 | 64.2 | |
| S16 | off filter | Spherical | Infinity | 0.379 | | | | |
| S17 | | Spherical | Infinity | 0.000 | | | | |

Note:
The reference wavelength is 587.5618 nm

Each parameter in Table 5a represents the same meaning as that in the optical system of FIG. 1a.

Table 5b shows higher-order coefficients that can be used for each aspherical lens surface of the optical system of FIG. 5a, where a shape of each aspherical lens surface can be defined by the formula given in the optical system of FIG. 1a.

TABLE 5b
Optical system of FIG. 5a
Aspherical coefficients

| Surface | | | | | | | |
|---|---|---|---|---|---|---|---|
| Number | S1 | S2 | S3 | S4 | S5 | S6 | S7 |
| K | −1.83E+00 | 9.90E+01 | −9.90E+01 | −4.63E+00 | −4.15E+01 | −2.36E+01 | 9.90E+01 |
| A4 | −5.61E−04 | −1.72E−02 | −4.38E−03 | −7.55E−02 | 7.36E−02 | 6.98E−03 | −7.21E−02 |
| A6 | −1.20E−02 | 1.19E−02 | 1.17E−01 | 1.89E−01 | −2.78E−01 | 2.05E−02 | 1.38E−01 |
| A8 | 1.59E−02 | −3.58E−02 | −4.49E−01 | −3.53E−01 | 4.74E−01 | −1.56E−01 | −1.85E−01 |
| A10 | 1.00E−02 | −1.64E−01 | 8.83E−01 | 4.08E−01 | −6.42E−01 | 2.71E−01 | 1.49E−01 |
| A12 | −9.06E−02 | 6.57E−01 | −1.14E+00 | −2.86E−01 | 6.23E−01 | −2.74E−01 | −6.19E−02 |
| A14 | 1.45E−01 | −1.06E+00 | 9.24E−01 | 8.13E−02 | −4.17E−01 | 1.72E−01 | −3.05E−03 |
| A16 | −1.09E−01 | 8.84E−01 | −4.66E−01 | 2.50E−02 | 1.83E−01 | −6.46E−02 | 1.40E−02 |
| A18 | 3.84E−02 | −3.72E−01 | 1.41E−01 | −2.18E−02 | −4.54E−02 | 1.35E−02 | −4.89E−03 |
| A20 | −4.73E−03 | 6.21E−02 | −2.08E−02 | 3.79E−03 | 4.75E−03 | −1.19E−03 | 5.43E−04 |
| Surface | | | | | | | |
| Number | S8 | S9 | S10 | S11 | S12 | S13 | S14 |
| K | 7.34E+01 | 4.10E+00 | 8.99E+01 | −9.73E+00 | −6.20E+01 | −1.65E+01 | −3.38E+00 |
| A4 | −2.19E−01 | −6.75E−02 | 1.83E−02 | 5.47E−03 | −8.51E−02 | −1.41E−01 | −5.49E−02 |
| A6 | 2.99E−01 | 2.25E−01 | 1.14E−01 | −2.52E−02 | 1.17E−01 | 1.17E−01 | 1.95E−02 |
| A8 | −3.89E−01 | −3.27E−01 | −1.96E−01 | 1.89E−02 | −6.79E−02 | −6.17E−02 | −5.11E−03 |
| A10 | 3.51E−01 | 2.52E−01 | 1.46E−01 | −1.01E−02 | 2.25E−02 | 2.05E−02 | 7.71E−04 |
| A12 | −2.15E−01 | −1.18E−01 | −6.31E−02 | 3.40E−03 | −4.68E−03 | −4.28E−03 | −3.83E−05 |
| A14 | 9.15E−02 | 3.44E−02 | 1.68E−02 | −6.63E−04 | 6.30E−04 | 5.68E−04 | −6.63E−06 |
| A16 | −2.66E−02 | −5.96E−03 | −2.68E−03 | 4.80E−05 | −5.29E−05 | −4.65E−05 | 1.27E−06 |
| A18 | 4.85E−03 | 5.48E−04 | 2.34E−04 | 4.12E−06 | 2.51E−06 | 2.15E−06 | −8.33E−08 |
| A20 | −4.09E−04 | −1.96E−05 | −8.55E−06 | −6.09E−07 | −5.19E−08 | −4.28E−08 | 2.01E−09 |

FIG. 5b illustrates a longitudinal spherical aberration curve, an astigmatic field curve, and a distortion curve of the optical system of FIG. 5a. According to the longitudinal spherical aberration curves illustrated in FIG. 5b, the longitudinal spherical aberration of the optical system for light rays with wavelengths of 470.0000 nm, 510.0000 nm, 587.5618 nm, 610.0000 nm, and 650.0000 nm is ranged from −0.025 mm to 0.02 mm. According to the astigmatic field curves illustrated in FIG. 5b, the astigmatism of the optical system for a light ray with the wavelength of 587.5618 nm in the tangential and sagittal directions is ranged from −0.01 mm to 0.03 mm. According to the distortion curves illustrated in FIG. 5b, the distortion of the optical system for the light ray with the wavelength of 587.5618 nm is ranged from 0.0% and 2.0%. As illustrated in FIG. 5b, the optical system of FIG. 5a can achieve good imaging quality.

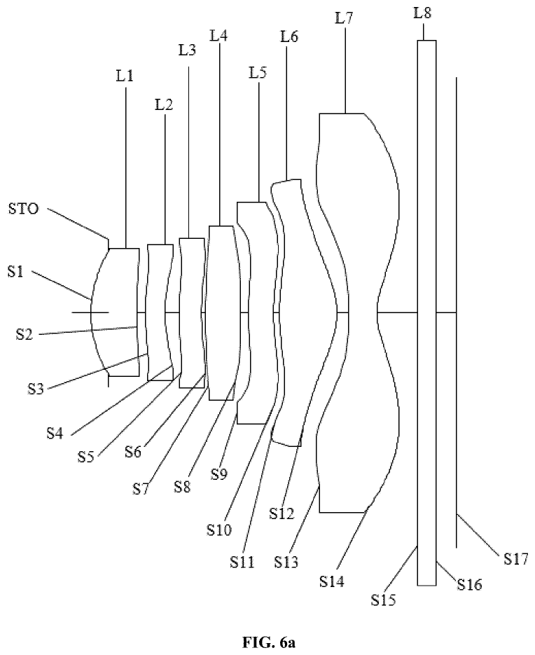

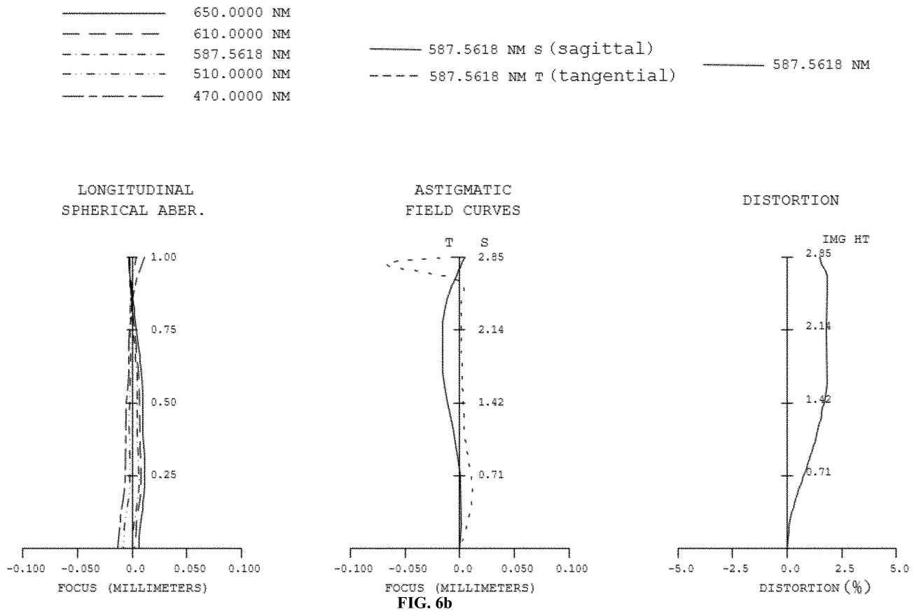

Referring to FIG. 6a and FIG. 6b, the optical system in this implementation includes the first lens L1, the second lens L2, the third lens L3, the fourth lens L4, the fifth lens L5, the sixth lens L6, and the seventh lens L7 which are sequentially arranged from the object side to the image side along the optical axis of the optical system.

The first lens L1 has a positive refractive power. The object-side surface S1 of the first lens L1 is convex near the optical axis and is convex at a circumference. The image-side surface S2 of the first lens L1 is concave near the optical axis and is convex at a circumference.

The second lens L2 has a negative refractive power. The object-side surface S3 of the second lens L2 is convex near the optical axis and is convex at a circumference. The image-side surface S4 of the second lens L2 is concave near the optical axis and is concave at a circumference.

The third lens L3 has a negative refractive power. The object-side surface S5 of the third lens L3 is convex near the optical axis and is convex at a circumference. The image-side surface S6 of the third lens L3 is concave near the optical axis and is concave at a circumference.

The fourth lens L4 has a positive refractive power. The object-side surface S7 of the fourth lens L4 is convex near the optical axis and is convex at a circumference. The image-side surface S8 of the fourth lens L4 is concave near the optical axis and is concave at a circumference.

The fifth lens L5 has a negative refractive power. The object-side surface S9 of the fifth lens L5 is convex near he optical axis and is concave at a circumference. The image-side surface S10 of the fifth lens L5 is concave near the optical axis and is convex at a circumference.

The sixth lens L6 has a positive refractive power. The object-side surface S11 of the sixth lens L6 is convex near the optical axis and is convex at a circumference. The image-side surface 12 of the sixth lens L6 is convex near the optical axis and is concave at a circumference.

The seventh lens L7 has a negative refractive power. The object-side surface 13 of the seventh lens L7 is concave near the optical axis and is convex at a circumference. The image-side surface 14 of the seventh lens L7 is concave near the optical axis and is convex at a circumference.

The other structures of the optical system of FIG. 6a are identical with the optical system of FIG. 1a, reference can be made to the optical system of FIG. 1a.

Table 6a illustrates characteristics of the optical system in this implementation. Each of Y radius thickness and focal length is in units of millimeter (mm).

TABLE 6a
Optical system of FIG. 6a
f = 4.08 mm, FNO = 1.95, FOV = 80.80°

| Surface | Surface | | | | | Refractive | Abbe | Focal |
|---|---|---|---|---|---|---|---|---|
| Number | Name | Shape | Y Radius | Thickness | Material | Index | Number | length |
| Object | | Spherical | Infinity | Infinity | | | | |
| number | | | | | | | | |
| STO | | Spherical | Infinity | −0.197 | | | | |
| S1 | First lens | Aspherical | 1.607 | 0.532 | Plastic | 1.54 | 56.1 | 3.97 |
| S2 | | Aspherical | 5.53 | 0.100 | | | | |
| S3 | Second lens | Aspherical | 3.126 | 0.230 | Plastic | 1.67 | 19.2 | −11.10 |
| S4 | | Aspherical | 2.137 | 0.161 | | | | |
| S5 | Third lens | Aspherical | 4.332 | 0.261 | Plastic | 1.64 | 23.5 | −157.59 |
| S6 | | Aspherical | 4.055 | 0.047 | | | | |
| S7 | Fourth lens | Aspherical | 7.771 | 0.400 | Plastic | 1.54 | 56.1 | 45.96 |
| S8 | | Aspherical | 11.069 | 0.100 | | | | |
| S9 | Fifth lens | Aspherical | 4.93 | 0.290 | Plastic | 1.67 | 19.2 | −10.31 |
| S10 | | Aspherical | 2.811 | 0.068 | | | | |
| S11 | Sixth lens | Aspherical | 2.447 | 0.670 | Plastic | 1.54 | 56.1 | 1.37 |
| S12 | | Aspherical | −0.968 | 0.134 | | | | |
| S13 | Seventh lens | Aspherical | −4.955 | 0.330 | Plastic | 1.53 | 55.8 | −1.36 |
| S14 | | Aspherical | 0.87 | 0.473 | | | | |
| S15 | Infrared cut- | Spherical | Infinity | 0.210 | Glass | 1.52 | 64.2 | |
| S16 | off filter | Spherical | Infinity | 0.244 | | | | |
| S17 | | Spherical | Infinity | 0.000 | | | | |

Note:
The reference wavelength is 587.5618 nm

Each parameter in Table 6a represents the same meaning as that in the optical system of FIG. 1a.

Table 6b shows higher-order coefficients that can be used for each aspherical lens surface of the optical system of FIG. 6a, where a shape of each aspherical lens surface can be defined by the formula given in the optical system of FIG. 1a.

TABLE 6b
Optical system of FIG. 6a
Aspherical coefficients

| Surface | | | | | | | |
|---|---|---|---|---|---|---|---|
| Number | S1 | S2 | S3 | S4 | S5 | S6 | S7 |
| K | 2.00E−02 | −1.40E+01 | −2.76E+01 | −2.86E+00 | −5.38E+01 | −2.60E+01 | 5.19E+01 |
| A4 | −1.88E−03 | −7.09E−02 | −9.71E−02 | −1.17E−01 | −1.21E−02 | −1.85E−01 | −3.50E−01 |
| A6 | 7.72E−02 | −7.28E−02 | 2.33E−01 | 2.71E−01 | 5.62E−01 | 1.87E+00 | 2.13E+00 |
| A8 | −6.68E−01 | 1.93E+00 | −2.17E+00 | −1.54E+00 | −7.61E+00 | −9.97E+00 | −7.82E+00 |
| A10 | 3.77E+00 | −1.25E+01 | 1.49E+01 | 8.16E+00 | 4.34E+01 | 3.14E+01 | 1.75E+01 |
| A12 | −1.28E+01 | 4.77E+01 | −6.11E+01 | −2.87E+01 | −1.51E+02 | −6.48E+01 | −2.25E+01 |
| A14 | 2.61E+0I | −1.14E+02 | 1.48E+02 | 6.11E+01 | 3.29E+02 | 8.86E+01 | 1.33E+01 |
| A16 | −3.13E+01 | 1.66E+02 | −2.15E+02 | −7.98E+01 | −4.38E+02 | −7.91E+01 | 1.14E+00 |
| A18 | 2.00E+01 | −1.32E+02 | 1.71E+02 | 5.82E+01 | 3.22E+02 | 4.22E+01 | −5.10E+00 |
| A20 | −5.14E+00 | 4.41E+01 | −5.81E+01 | −1.76E+01 | −9.93E+01 | −1.01E+01 | 1.67E+00 |
| Surface | | | | | | | |
| Number | S8 | S9 | S10 | S11 | S12 | S13 | S14 |
| K | 9.15E+01 | −6.06E+01 | −3.50E+01 | −2.82E+01 | −6.39E+00 | −7.81E+00 | −6.36E+00 |
| A4 | −2.48E−01 | 1.69E−02 | −1.39E−02 | −8.09E−02 | −8.45E−02 | −1.32E−01 | −1.21E−01 |
| A6 | 8.77E−02 | −5.51E−01 | −4.65E−01 | −8.60E−02 | 2.83E−01 | 2.16E−02 | 6.23E−02 |
| A8 | 8.22E−01 | 1.98E+00 | 1.88E+00 | 7.15E−01 | −4.38E−01 | 3.30E−02 | −1.70E−02 |
| A10 | −3.93E+00 | −4.39E+00 | −4.06E+00 | −1.66E+00 | 5.12E−01 | −1.03E−02 | −1.17E−03 |
| A12 | 8.12E+00 | 5.16E+00 | 5.05E+00 | 1.94E+00 | −4.27E−01 | −2.80E−03 | 2.49E−03 |
| A14 | −9.10E+00 | −2.66E+00 | −3.75E+00 | −1.31E+00 | 2.30E−01 | 2.13E−03 | −8.35E−04 |
| A16 | 5.88E+00 | −2.35E−01 | 1.64E+00 | 5.17E−01 | −7.35E−02 | −4.84E−04 | 1.38E−04 |
| A18 | −2.08E+00 | 8.05E−01 | −3.88E−01 | −1.11E−01 | 1.27E−02 | 5.10E−05 | −1.15E−05 |
| A20 | 3.10E−01 | −2.32E−01 | 3.85E−02 | 9.89E−03 | −9.14E−04 | −2.13E−06 | 3.85E−07 |

FIG. 6b illustrates a longitudinal spherical aberration curve, an astigmatic field curve, and a distortion curve of the optical system of FIG. 6a. According to the longitudinal spherical aberration curves illustrated in FIG. 6b, the longitudinal spherical aberration of the optical system for light rays with wavelengths of 470.0000 nm, 510.0000 nm, 587.5618 nm, 610.0000 nm, and 650.0000 nm is ranged from −0.01 mm to 0.01 mm. According to the astigmatic field curves illustrated in FIG. 6b, the astigmatism of the optical system for a light ray with the wavelength of 587.5618 nm in the tangential and sagittal directions is ranged from −0.06 mm to 0.01 mm. According to the distortion curves illustrated in FIG. 6b, the distortion of the optical system for the light ray with the wavelength of 587.5618 nm is ranged from 0.0% and 2.0%. As illustrated in FIG. 6b, the optical system of FIG. 6a can achieve good imaging quality.

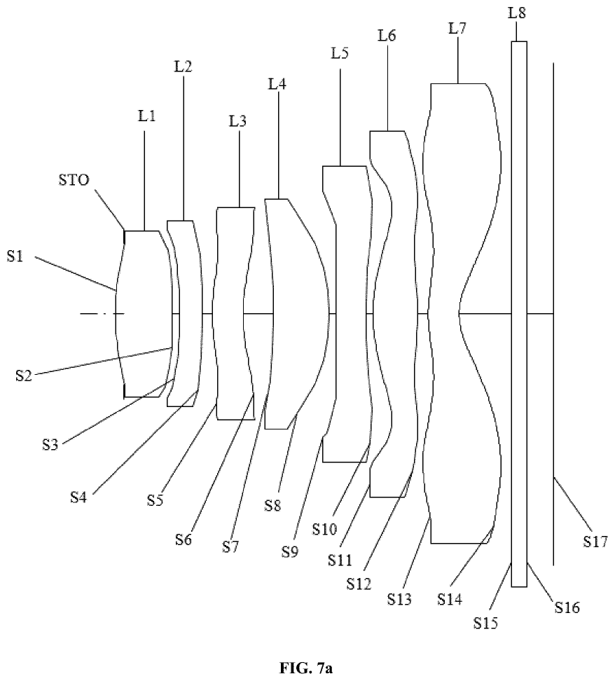

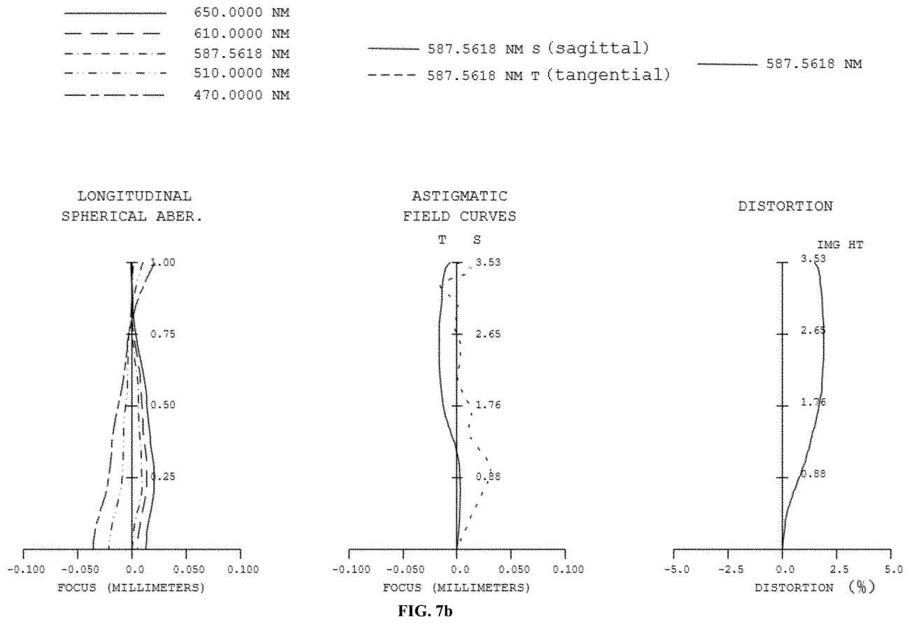

Referring to FIG. 7a and FIG. 7b, the optical system in this implementation includes the first lens L1, the second lens L2, the third lens L3, the fourth lens L4, the fifth lens L5, the sixth lens L6, and the seventh lens L7 which are sequentially arranged from the object side to the image side along the optical axis of the optical system.

The first lens L1 has a positive refractive power. The object-side surface S1 of the first lens L1 is convex near the optical axis and is convex at a circumference. The image-side surface S2 of the first lens L1 is convex near the optical axis and is convex at a circumference.

The second lens L2 has a negative refractive power. The object-side surface S3 of the second lens L2 is concave near the optical axis and is concave at a circumference. The image-side surface S4 of the second lens L2 is convex near the optical axis and is convex at a circumference.

The third lens L3 has a positive refractive power. The object-side surface S5 of the third lens L3 is convex near the optical axis and is convex at a circumference. The image-side surface S6 of the third lens L3 is concave near the optical axis and is concave at a circumference.

The fourth lens L4 has a positive refractive power. The object-side surface S7 of the fourth lens L4 is concave near the optical axis and is convex at a circumference. The image-side surface S8 of the fourth lens L4 is convex near the optical axis and is convex at a circumference.

The fifth lens L5 has a positive refractive power. The object-side surface S9 of the fifth lens L5 is convex near the optical axis and is concave at a circumference. The image-side surface S10 of the fifth lens L5 is convex near the optical axis and is convex at a circumference.

The sixth lens L6 has a positive refractive power. The object-side surface S11 of the sixth lens L6 is convex near the optical axis and is concave at a circumference. The image-side surface S12 of the sixth lens L6 is convex near the optical axis and is convex at a circumference.

The seventh lens L7 has a negative refractive power. The object-side surface S13 of the seventh lens L7 is convex near the optical axis and is convex at a circumference. The image-side surface S14 of the seventh lens L7 is concave near the optical axis and is convex at a circumference.

The other structures of the optical system of FIG. 7a are identical with the optical system of FIG. 1a, reference can be made to the optical system of FIG. 1a.

Table 7a illustrates characteristics of the optical system in this implementation. Each of Y radius, thickness, and focal length is in units of millimeter (mm).

TABLE 7a
Optical system of FIG. 7a
f = 3.95 mm, FNO = 1.90, FOV = 82.80°

| Surface | Surface | | | | | Refractive | Abbe | Focal |
|---|---|---|---|---|---|---|---|---|
| Number | Name | Shape | Y Radius | Thickness | Material | Index | Number | length |
| Object | | Spherical | Infinity | Infinity | | | | |
| number | | | | | | | | |
| STO | | Spherical | Infinity | −0.116 | | | | |
| S1 | First lens | Aspherical | 3.521 | 0.781 | Plastic | 1.54 | 56.1 | 5.16 |
| S2 | | Aspherical | −12.807 | 0.100 | | | | |
| S3 | Second lens | Aspherical | −5.799 | 0.310 | Plastic | 1.67 | 19.2 | −11.77 |
| S4 | | Aspherical | −22.234 | 0.131 | | | | |
| S5 | Third lens | Aspherical | 2.698 | 0.420 | Plastic | 1.67 | 19.2 | 34.44 |
| S6 | | Aspherical | 2.864 | 0.411 | | | | |
| S7 | Fourth lens | Aspherical | −19.988 | 0.750 | Plastic | 1.54 | 56.1 | 109.02 |
| S8 | | Aspherical | −15.148 | 0.100 | | | | |
| S9 | Fifth lens | Aspherical | 27.844 | 0.410 | Plastic | 1.67 | 19.2 | 21.46 |
| S10 | | Aspherical | −29.674 | 0.100 | | | | |
| S11 | Sixth lens | Aspherical | 2.947 | 0.600 | Plastic | 1.54 | 56.1 | 3.90 |
| S12 | | Aspherical | −7.027 | 0.150 | | | | |
| S13 | Seventh lens | Aspherical | 2.124 | 0.420 | Plastic | 1.53 | 55.8 | −3.38 |
| S14 | | Aspherical | 0.909 | 0.706 | | | | |
| S15 | Infrared cut- | Spherical | Infinity | 0.210 | Glass | 1.52 | 64.2 | |
| S16 | off filter | Spherical | Infinity | 0.372 | | | | |
| S17 | | Spherical | Infinity | 0.000 | | | | |

Note:
The reference wavelength is 587.5618 nm

Each parameter in Table 7a represents the same meaning as that in the optical system of FIG. 1a.

Table 7b shows higher-order coefficients that can be used for each aspherical lens surface of the optical system of FIG. 7a, where a shape of each aspherical lens surface can be defined by the formula given in the optical system of FIG. 1a.

TABLE 7b
Optical system of FIG. 7a
Aspherical coefficients

| Surface | | | | | | | |
|---|---|---|---|---|---|---|---|
| Number | S1 | S2 | S3 | S4 | S5 | S6 | S7 |
| K | −4.04E+00 | 9.87E+01 | −3.98E+01 | 9.90E+01 | −3.73E+01 | −1.42E+01 | −9.90E+01 |
| A4 | −5.38E−03 | −3.18E−02 | −1.25E−02 | −7.18E−02 | 6.65E−02 | 6.97E−03 | −8.60E−02 |
| A6 | −5.25E−03 | 4.47E−03 | 6.90E−02 | 1.65E−01 | −2.79E−01 | 7.50E−03 | 1.36E−01 |
| A8 | −3.03E−02 | −1.82E−02 | −3.11E−01 | −3.67E−01 | 4.43E−01 | −1.19E−01 | −1.08E−01 |
| A10 | 1.18E−01 | −9.44E−02 | 7.09E−01 | 5.85E−01 | −5.45E−01 | 2.12E−01 | 1.93E−02 |
| A12 | −2.53E−01 | 4.31E−01 | −9.52E−01 | −6.11E−01 | 4.85E−01 | −2.12E−01 | 5.53E−02 |
| A14 | 3.06E−01 | −7.12E−01 | 7.81E−01 | 4.08E−01 | −2.85E−01 | 1.32E−01 | −6.29E−02 |
| A16 | −2.10E−01 | 5.76E−01 | −4.06E−01 | −1.73E−01 | 1.03E−01 | −5.07E−02 | 2.99E−02 |
| A18 | 7.37E−02 | −2.30E−01 | 1.28E−01 | 4.36E−02 | −2.06E−02 | 1.10E−02 | −6.69E−03 |
| A20 | −9.77E−03 | 3.65E−02 | −1.87E−02 | −4.98E−03 | 1.71E−03 | −1.04E−03 | 5.73E−04 |
| Surface | | | | | | | |
| Number | S8 | S9 | S10 | S11 | S12 | S13 | S14 |
| K | 7.05E+01 | 9.90E+01 | 5.27E+01 | −6.30E+00 | −8.89E+01 | −1.21E+01 | −3.13E+00 |
| A4 | −4.24E−01 | −1.65E−01 | 8.39E−02 | −2.93E−02 | −5.60E−02 | −1.83E−01 | −1.10E−01 |
| A6 | 7.71E−01 | 5.52E−01 | 1.16E−01 | 9.01E−02 | 1.27E−01 | 1.42E−01 | 6.54E−02 |
| A8 | −9.56E−01 | −8.10E−01 | −2.85E−01 | −1.04E−01 | −7.97E−02 | −7.31E−02 | −2.69E−02 |
| A10 | 7.51E−01 | 6.63E−01 | 2.40E−01 | 6.37E−02 | 2.40E−02 | 2.45E−02 | 7.31E−03 |
| A12 | −3.66E−01 | −3.34E−01 | −1.11E−01 | −2.60E−02 | −3.81E−03 | −5.22E−03 | −1.30E−03 |
| A14 | 1.07E−01 | 1.06E−01 | 3.07E−02 | 7.18E−03 | 2.76E−04 | 7.03E−04 | 1.48E−04 |
| A16 | −1.77E−02 | −2.06E−02 | −5.05E−03 | −1.27E−03 | 4.28E−08 | −5.81E−05 | −1.04E−05 |
| A18 | 1.41E−03 | 2.30E−03 | 4.56E−04 | 1.29E−04 | −1.09E−06 | 2.70E−06 | 4.08E−07 |
| A20 | −3.67E−05 | −1.15E−04 | −1.72E−05 | −5.67E−06 | 3.95E−08 | −5.41E−08 | −6.88E−09 |

FIG. 7b illustrates a longitudinal spherical aberration curve, an astigmatic field curve, and a distortion curve of the optical system of FIG. 7a. According to the longitudinal spherical aberration curves illustrated in FIG. 7b, the longitudinal spherical aberration of the optical system for light rays with wavelengths of 470.0000 nm, 510.0000 nm, 587.5618 nm, 610.0000 nm, and 650.0000 nm is ranged from −0.04 mm to 0.02 mm. According to the astigmatic field curves illustrated in FIG. 7b, the astigmatism of the optical system for a light ray with the wavelength of 587.5618 nm in the tangential and sagittal directions is ranged from −0.01 mm to 0.03 mm. According to the distortion curves illustrated in FIG. 7b, the distortion of the optical system for the light ray with the wavelength of 587.5618 nm is ranged from 0.0% and 2.0%. As illustrated in FIG. 7b, the optical system of FIG. 7a can achieve good imaging quality.

Table 8 shows values of (Y72*TL)/(ET7*f), TL/EPD, (|AL1S1|+|AL2S1|)/f, MVd/f, ET1/(CT1*f), ET7/(CT7*f), EPD/f, (MIN6*MAX7)/(MAX6*MIN7), (CT5+CT7)/CT6, TL/ImgH of the optical system according to the first to seventh implementations.

TABLE 8

| | | | (\|AL1S1\| + | | ET1/ |
|---|---|---|---|---|---|
| | (Y72*TL)/(ET7*f) | TL/EPD | \|AL2S1\|)/f | MVd/f | (CT1*f) |
| First | 7.437 | 2.746 | 9.754 | 13.991 | 0.188 |
| implementation | | | | | |
| Second | 9.036 | 2.742 | 18.909 | 12.606 | 0.184 |
| implementation | | | | | |
| Third | 4.984 | 2.143 | 18.205 | 13.462 | 0.132 |
| implementation | | | | | |
| Fourth | 7.328 | 2.244 | 13.359 | 13.037 | 0.143 |
| implementation | | | | | |
| Fifth | 6.711 | 2.924 | 12.886 | 12.114 | 0.153 |
| implementation | | | | | |
| Sixth | 6.741 | 2.725 | 15.671 | 16.05 | 0.211 |
| implementation | | | | | |
| Seventh | 6.753 | 2.876 | 10.886 | 12.532 | 0.152 |
| implementation | | | | | |
| | | | (MIN6*MAX7)/ | (CT5 + | TL/ |
| | ET7/(CT7*f) | EPD/f | (MAX6* MIN7) | CT7)/CT6 | ImgH |
| First | 0.470 | 0.505 | 0.204 | 0.903 | 1.36 |
| implementation | | | | | |
| Second | 0.374 | 0.495 | 0.207 | 1.323 | 1.324 |
| implementation | | | | | |
| Third | 0.528 | 0.633 | 0.261 | 1.068 | 1.581 |
| implementation | | | | | |
| Fourth | 0.416 | 0.606 | 0.223 | 1.092 | 1.475 |
| implementation | | | | | |
| Fifth | 0.324 | 0.513 | 0.364 | 1.812 | 1.734 |
| implementation | | | | | |
| Sixth | 0.495 | 0.5 | 0.15 | 0.925 | 1.491 |
| implementation | | | | | |
| Seventh | 0.457 | 0.526 | 0.254 | 1.384 | 1.692 |
| implementation | | | | | |

As illustrated in Table 8, each implementation of the disclosure satisfies the following expressions. 4≤(Y72*TL)/(ET7*f)≤10, 2≤TL/EPD≤3, 9≤(|AL1S1|+|AL2S1|)/f≤20, 10≤MVd/f≤20, 0≤ET1/(CT1*f)≤1 mm⁻¹, 0≤ET7/(CT7*f)≤1 mm⁻¹, 0≤EPD/f≤1, 0≤(MIN6*MAX7)/(MAX6*MIN7)≤1, 0≤(CT5+CT7)/CT6≤2, 1≤TL/ImgH≤2.

Various technical features of the above implementations can be combined arbitrarily. For the sake of convenience, not all possible combinations of the various technical features in the above implementations are described. However, as long as there is no contradiction in the combinations of these technical features, it should be considered to fall within the scope of the present disclosure.

While the present disclosure has been described specifically and in detail above with reference to several implementations, the scope of the present disclosure is not limited thereto. As will occur to those skilled in the art, the present disclosure is susceptible to various modifications and changes without departing from the spirit and principle of the present disclosure. Therefore, the scope of the present disclosure should be determined by the scope of the claims.

What is claimed is:

1. An optical system, comprising a first lens having a positive refractive power, a second lens having a refractive power, a third lens having a refractive power, a fourth lens having a refractive power, a fifth lens having a refractive power, a sixth lens having a positive refractive power, a seventh lens having a negative refractive power which are sequentially arranged from an object side to an image side along an optical axis of the optical system, wherein the first lens has an object-side surface which is convex near the optical axis;
the seventh lens has an image-side surface which is concave near the optical axis; and
the optical system satisfies the following expression:
4≤(Y72*TL)/(ET7*f)≤10;
wherein Y72 represents a maximum optical effective radius of the image-side surface of the seventh lens, TL represents a distance along the optical axis from the object-side surface of the first lens to an imaging plane of the optical system, ET7 represents a distance along the optical axis from an object-side surface of the seventh lens at a maximum optical effective radius to the image-side surface of the seventh lens at the maximum optical effective radius, and f represents a focal length of the optical system.

2. The optical system of claim 1, wherein the optical system satisfies the following expression:
2≤TL/EPD≤3;
wherein EPD represents an entrance pupil radius of the optical system.

3. The optical system of claim 1, wherein the optical system satisfies the following expression:
9≤(|AL1S1|+|AL2S1|)/f≤20;
wherein AL1S1 represents a maximum value of an acute angle between a tangent plane within a maximum optical effective radius of the object-side surface of the first lens and a plane perpendicular to the optical axis, and AL1S2 represents a maximum value of an acute angle between a tangent plane within a maximum optical effective radius of the object-side surface of the second lens and the plane perpendicular to the optical axis.

4. The optical system of claim 1, wherein the optical system satisfies the following expression:
10≤MVd/f≤20;
wherein MVd represents an average of Abbe numbers of the first to seventh lenses.

5. The optical system of claim 1, wherein the optical system satisfies the following expression:
0≤ET1/(CT1*f)≤1 mm⁻¹;
wherein ET1 represents a distance along the optical axis from the object-side surface of the first lens at a maximum optical effective radius to an image-side surface of the first lens at a maximum optical effective radius, and CT1 represents a thickness of the first lens along the optical axis.

6. The optical system of claim 1, wherein the optical system satisfies the following expression:
0≤ET7/(CT7*f)≤1 mm⁻¹;
wherein CT7 represents a thickness of the seventh lens along the optical axis.

7. The optical system of claim 1, wherein the optical system satisfies the following expression:
0≤EPD/f≤1;
wherein EPD represents an entrance pupil radius of the optical system.

8. The optical system of claim 1, wherein the optical system satisfies the following expression:
0≤(MIN6*MAX7)/(MAX6*MIN7)≤1;
wherein MIN6 represents a minimum thickness of the sixth lens along the optical axis within a maximum optical effective radius of an object-side surface of the sixth lens as well as a maximum optical effective radius of an image-side surface of the sixth lens, MAX6 represents a maximum thickness of the sixth lens along the optical axis within the maximum optical effective radius of the object-side surface of the sixth lens as well as the maximum optical effective radius of the image-side surface of the sixth lens, MIN7 represents a minimum thickness of the seventh lens along the optical axis within a maximum optical effective radius of the object-side surface of the seventh lens as well as a maximum optical effective radius of the image-side surface of the seventh lens, MAX7 represents a maximum thickness of the seventh lens along the optical axis within the maximum optical effective radius of the object-side surface of the seventh lens as well as the maximum optical effective radius of the image-side surface of the seventh lens.

9. The optical system of claim 1, wherein the optical system satisfies the following expression:
0≤(CT5+CT7)/CT6≤2;
wherein CT5 represents a thickness of the fifth lens along the optical axis, CT6 represents a thickness of the sixth lens along the optical axis, and CT7 represents a thickness of the seventh lens along the optical axis.

10. The optical system of claim 1, wherein the optical system satisfies the following expression:
1≤TL/ImgH≤2;
wherein ImgH represents half of an image height corresponding to a maximum field angle of the optical system.

11. A lens module, comprising a lens barrel, an electronic photosensitive element, and an optical system, wherein
the optical system comprises a first lens having a positive refractive power, a second lens having a refractive power, a third lens having a refractive power, a fourth lens having a refractive power, a fifth lens having a refractive power, a sixth lens having a positive refractive power, a seventh lens having a negative refractive power which are sequentially arranged from an object side to an image side along an optical axis of the optical system, wherein
the first lens has an object-side surface which is convex near the optical axis;
the seventh lens has an image-side surface which is concave near the optical axis; and
the optical system satisfies the following expression:
4≤(Y72*TL)/(ET7*f)≤10;
wherein Y72 represents a maximum optical effective radius of the image-side surface of the seventh lens, TL represents a distance along the optical axis from the object-side surface of the first lens to an imaging plane of the optical system, ET7 represents a distance along the optical axis from an object-side surface of the seventh lens at a maximum optical effective radius to the image-side surface of the seventh lens at the maximum optical effective radius, and f represents a focal length of the optical system; and
the optical system is mounted in the lens barrel, and the electronic photosensitive element is arranged at the image side of the optical system.

12. The lens module of claim 11, wherein the optical system satisfies the following expression:
2≤TL/EPD≤3;
wherein EPD represents an entrance pupil radius of the optical system.

13. The lens module of claim 11, wherein the optical system satisfies the following expression:
9≤(|AL1S1|+|AL2S1|)/f≤20;
wherein AL1S1 represents a maximum value of an acute angle between a tangent plane within a maximum optical effective radius of the object-side surface of the first lens and a plane perpendicular to the optical axis, and AL1S2 represents a maximum value of an acute angle between a tangent plane within a maximum optical effective radius of the object-side surface of the second lens and the plane perpendicular to the optical axis.

14. The lens module of claim 11, wherein the optical system satisfies the following expression:
10≤MVd/f≤20;
wherein MVd represents an average of Abbe numbers of the first to seventh lenses.

15. The lens module of claim 11, wherein the optical system satisfies the following expression:
0≤ET1/(CT1*f)≤1 mm⁻¹;
wherein ET1 represents a distance along the optical axis from the object-side surface of the first lens at a maximum optical effective radius to an image-side surface of the first lens at a maximum optical effective radius, and CT1 represents a thickness of the first lens along the optical axis.

16. The lens module of claim 11, wherein the optical system satisfies the following expression:
0≤ET7/(CT7*f)≤1 mm⁻¹;
wherein CT7 represents a thickness of the seventh lens along the optical axis.

17. The lens module of claim 11, wherein the optical system satisfies the following expression:
0≤EPD/f≤1;
wherein EPD represents an entrance pupil radius of the optical system.

18. The lens module of claim 11, wherein the optical system satisfies the following expression:
0≤(MIN6*MAX7)/(MAX6*MIN7)≤1;
wherein MIN6 represents a minimum thickness of the sixth lens along the optical axis within a maximum optical effective radius of an object-side surface of the sixth lens as well as a maximum optical effective radius of an image-side surface of the sixth lens, MAX6 represents a maximum thickness of the sixth lens along the optical axis within the maximum optical effective radius of the object-side surface of the sixth lens as well as the maximum optical effective radius of the image-side surface of the sixth lens, MIN7 represents a minimum thickness of the seventh lens along the optical axis within a maximum optical effective radius of the object-side surface of the seventh lens as well as a maximum optical effective radius of the image-side surface of the seventh lens, MAX7 represents a maximum thickness of the seventh lens along the optical axis within the maximum optical effective radius of the object-side surface of the seventh lens as well as the maximum optical effective radius of the image-side surface of the seventh lens.

19. The lens module of claim 11, wherein the optical system satisfies the following expression:
0≤(CT5+CT7)/CT6≤2;
wherein CT5 represents a thickness of the fifth lens along the optical axis, CT6 represents a thickness of the sixth lens along the optical axis, and CT7 represents a thickness of the seventh lens along the optical axis.

20. An electronic device, comprising a housing and the lens module of claim 11, and the lens module is received in the housing.
